(19) United States
(12) Patent Application Publication
(10) Pub. No.: US 2012/0257847 A1
(43) Pub. Date: Oct. 11, 2012

(54) ROTARY WING AIRCRAFT INSTRUMENTED MOTION CONTROL BEARINGS

(76) Inventors: Charles J. Allred, Holly Springs, NC (US); Marshall W. Downing, Erie, PA (US); Zachary Fuhrer, Erie, PA (US); Mark R. Jolly, Raleigh, NC (US); Matthew A. Smith, Erie, PA (US)

(21) Appl. No.: 13/439,913

(22) Filed: Apr. 5, 2012

Related U.S. Application Data
(60) Provisional application No. 61/472,923, filed on Apr. 7, 2011.

(51) Int. Cl. F16C 27/06; B23P 17/00

(52) U.S. Cl. 384/221; 29/898.04

(57) ABSTRACT

Motion control bearings and methods making such with the capability to monitor properties therein is provided. Devices and methods for creating and using motion control bearings for rotary wing aircraft in particular are disclosed using wireless communication and monitoring of multiple load, motion and health related information items related to the bearing and blade at the wing hub. Static and dynamic blade orientation provides additional information on flight regime, thrust vectors, and gross vehicle weight. Power is provided using kinetic energy power harvesting.

### BACKGROUND

The invention relates generally to motion control bearings and methods of making motion control bearings for monitoring of properties therein. The invention relates to rotary wing aircraft and motion control bearings. The invention relates to motion control bearings in helicopter rotary wing systems.

Motion control bearings are configured to be attached between two controlled member structures in order to control relative motion between the two structures. The motion control bearings preferably include at least one elastomer laminate bonded to two distal surfaces subjected to relative motion. The motion control bearings control a motion.

### SUMMARY

In one aspect the invention includes a bearing device for a rotary wing aircraft. The bearing device provides a constrained relative motion between a first control member and a second control member. The bearing device comprises an elastomeric laminate, a first end bearing connector, a second end bearing connector and at least a first sensor member. The elastomeric laminate including a plurality of mold bonded alternating layers of nonelastomeric shims and elastomeric shims. The first end bearing connector bonded with a first end of the elastomeric laminate. The first end bearing connector for grounding with the first control member. The second end bearing connector bonded with a second distal end of the elastomeric laminate. The second end bearing connector for grounding with the second control member. The first sensor member coupled with the first end bearing connector, a wireless transmitter, and a kinetic energy power harvester. The kinetic energy power harvester is disposed proximate to the elastomeric laminate, wherein the kinetic energy power harvester extracts an electrical energy from a energy source to provide electricity to the bearing device, wherein the first sensor member senses a movement between the first end bearing connector and the second end bearing connector, and the wireless transmitter transmits sensor data of the sensed movement to a wireless receiver.

In one aspect, the invention includes a method of making a motion control bearing device for a rotary wing aircraft. The method of making the bearing device includes constraining a relative motion between a first control member and a second control member. The method comprises providing an elastomeric laminate, at least a first sensor member, a wireless transmitter, and a kinetic energy power harvester. The elastomeric laminate includes a plurality of mold bonded alternating layers of nonelastomeric shims and elastomeric shims. The elastomeric laminate includes a first end bearing connector bonded with a first end of the elastomeric laminate. The elastomeric laminate includes a second end bearing connector bonded with a second distal end of the elastomeric laminate. The kinetic energy power harvester extracts an electrical energy from a energy source to provide electricity to the bearing device, wherein the first sensor member senses a movement between the first end bearing connector and the second end bearing connector, and the wireless transmitter transmits sensor data of the sensed movement to a wireless receiver.

In another aspect, the invention includes a bearing device. The bearing device provides a constrained relative motion between a first control member and a second control member. The bearing device comprises an elastomeric laminate 16 and a sensing means. The elastomeric laminate includes a plurality of mold bonded alternating layers of nonelastomeric shims and elastomeric shims. The bearing device includes a first end bearing connector bonded with a first end of the elastomeric laminate, the first end bearing connector for grounding with the first control member. The bearing device including a second end bearing connector bonded with a second distal end of elastomeric laminate, the second end bearing connector for grounding with the second control member. The sensing means has a means for powering the sensing means, wherein the sensing means senses a movement between the first end bearing connector and the second end bearing connector, and transmits sensor data of the sensed movement to a wireless receiver.

### BRIEF DESCRIPTION OF THE DRAWINGS

FIG. 1 illustrates a side view of a rotary wing aircraft.

FIG. 2 illustrates detailed cross-section of motion control bearing location on rotary wing aircraft with wireless communications.

FIG. 3 illustrates a schematic of a motion control bearing positioned about the center hub of a rotary wing aircraft.

FIG. 4 illustrates a schematic of a motion control bearing.

FIG. 5 illustrates a flow diagram of a wireless sensor for a motion control bearing.

FIGS. 6-9 illustrate placement of sensors in an elastomeric device.

FIG. 10 illustrates a schematic of the CF bearing and the placement thereof in the hub configuration.

FIG. 11 illustrates wired communication through the fixed member of the CF bearing.

FIG. 12 illustrates the attachment of the bonded spherical elastomeric bearing package to major metal components.

FIG. 13 illustrates a section view of a bonded spherical elastomeric bearing with major metal components.

FIG. 14 illustrates positioning bonded spherical elastomeric bearing package in a mold.

FIG. 15 illustrates an exploded view of a rotary wing hub with the motion control bearing instrumented for load sensing.

FIGS. 16 and 17 illustrate a sectional view of the motion control bearing in a portion of a rotary wing hub.

FIG. 18 illustrates the kinetic energy power harvester.

FIGS. 19 and 20 illustrate an exploded view of the kinetic energy power harvester without an elastomeric element.

FIG. 21 illustrates a bottom view of the kinetic energy power harvester without an elastomeric element, including the winding and plurality of magnets.

FIG. 22 illustrates a sectional side view of the kinetic energy power harvester without the elastomeric element, including the winding.

FIG. 23 illustrates a perspective sectional side view of the kinetic energy power harvester without the elastomeric element, including the plurality of magnets.

FIG. 24 illustrates a perspective side view of the load sensing assembly.

FIG. 25 illustrates a control circuit for the load sensing assembly.

FIG. 26 illustrates a perspective exploded view of the load sensing assembly.

FIG. 27 illustrates the magnetic field associated with the motion control bearing.

FIG. 28 illustrates a longitudinally extending linear displacement sensor assembly.

FIG. 29 illustrates a schematic placement of multiple sensors.

FIG. 30 illustrates a schematic placement of multiple sensors.

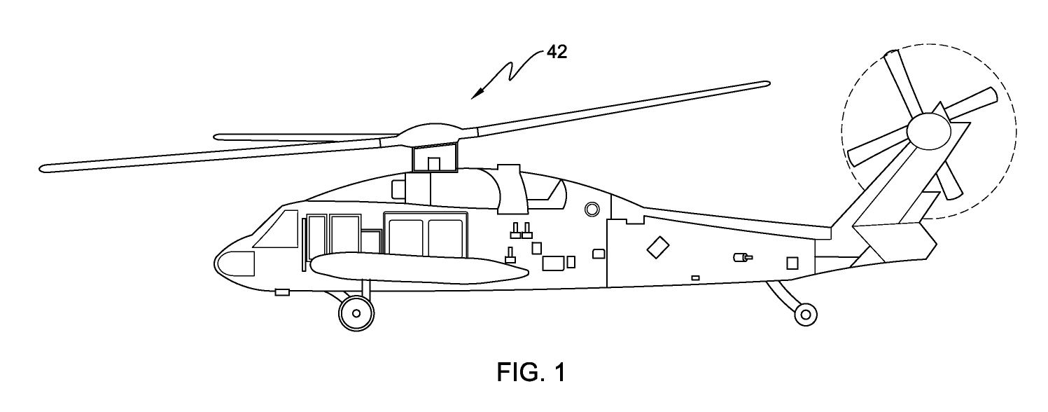

### DETAILED DESCRIPTION

Additional features and advantages of the invention will be set forth in the detailed description which follows, and in part will be readily apparent to those skilled in the art from that description or recognized by practicing the invention as described herein, including the detailed description which follows, the claims, as well as the appended drawings. Reference will now be made in detail to the present preferred embodiments of the invention, examples of which are illustrated in the accompanying drawings.

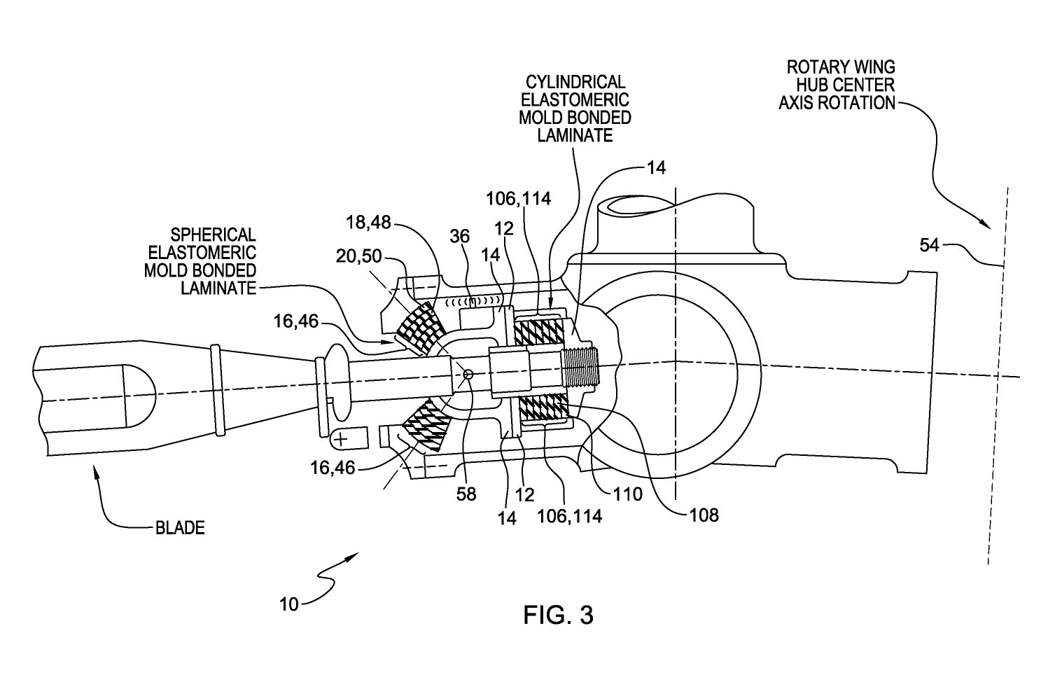

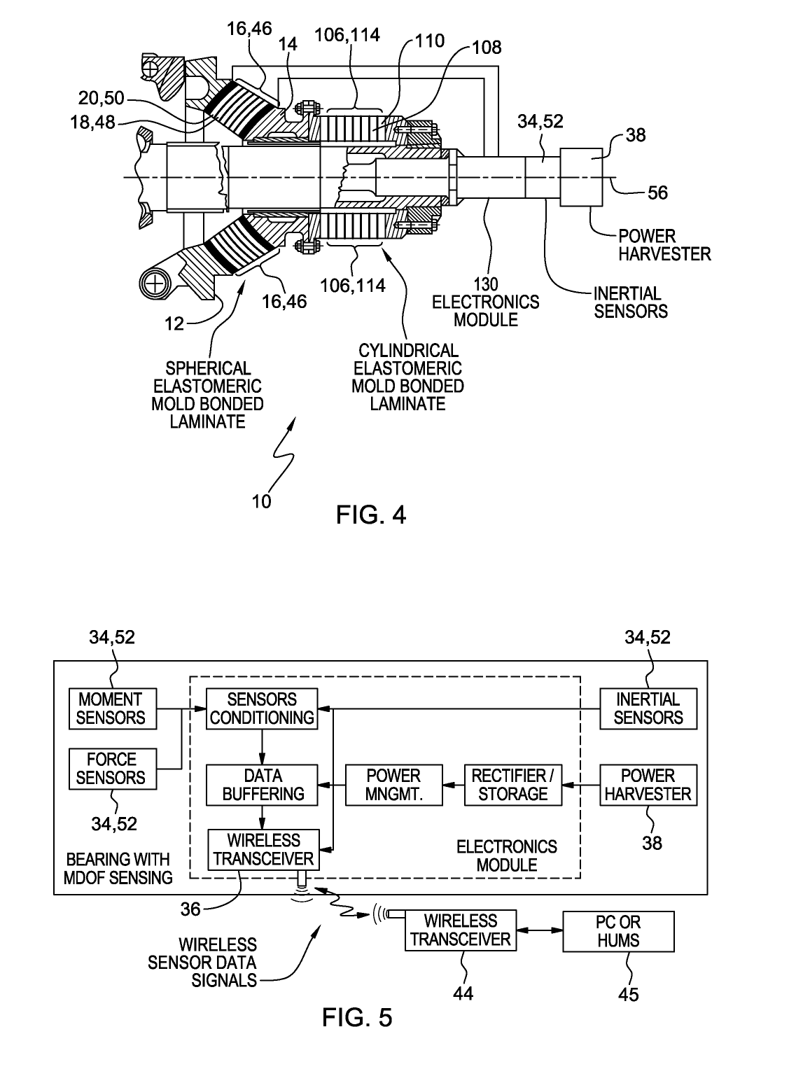

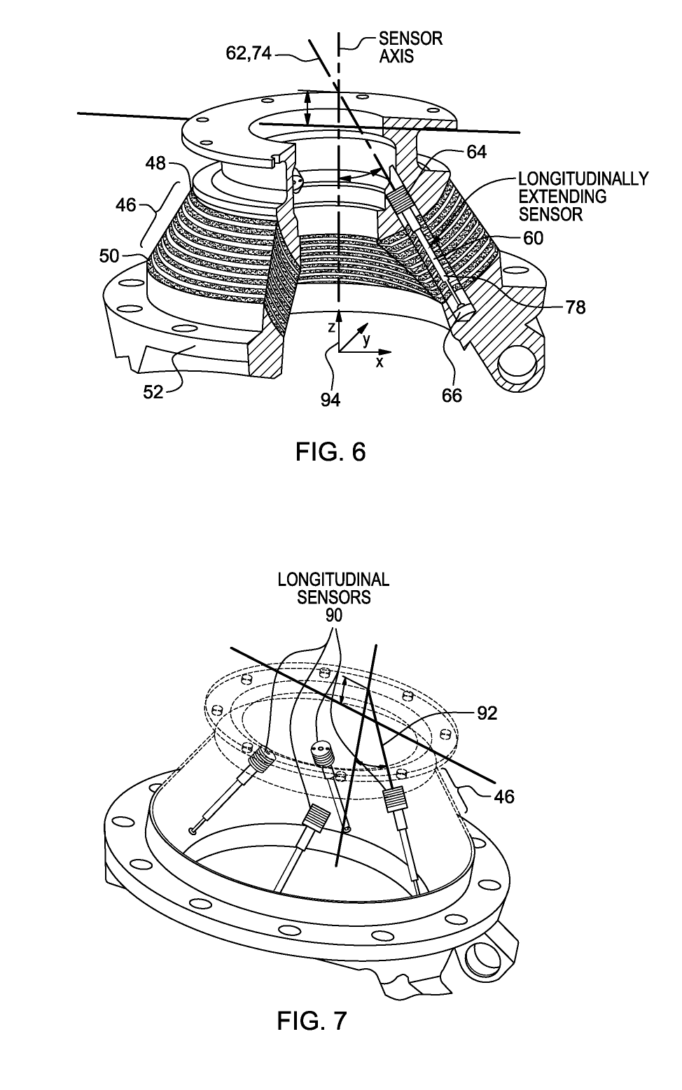

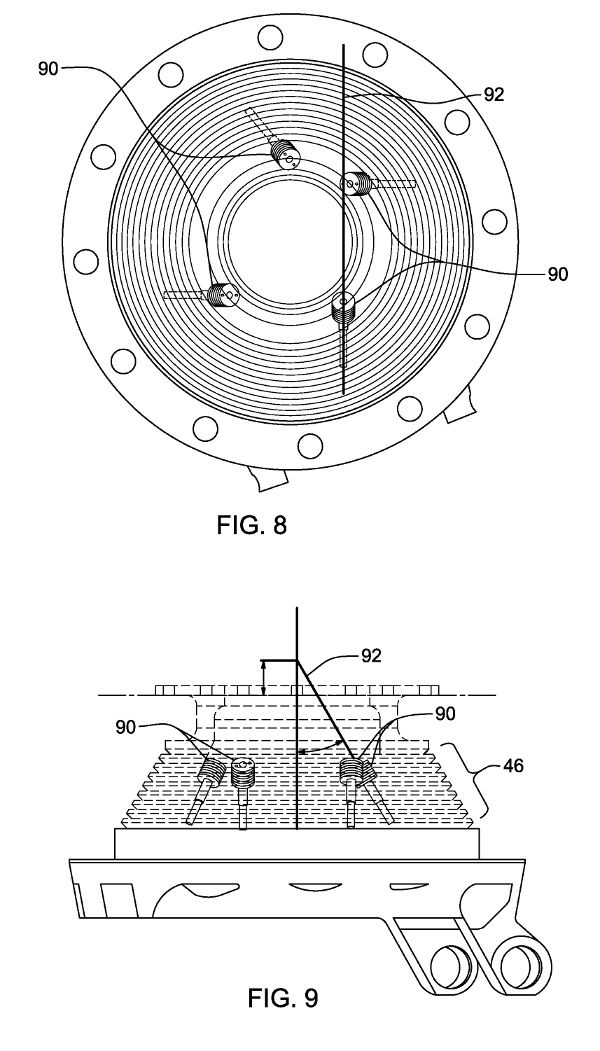

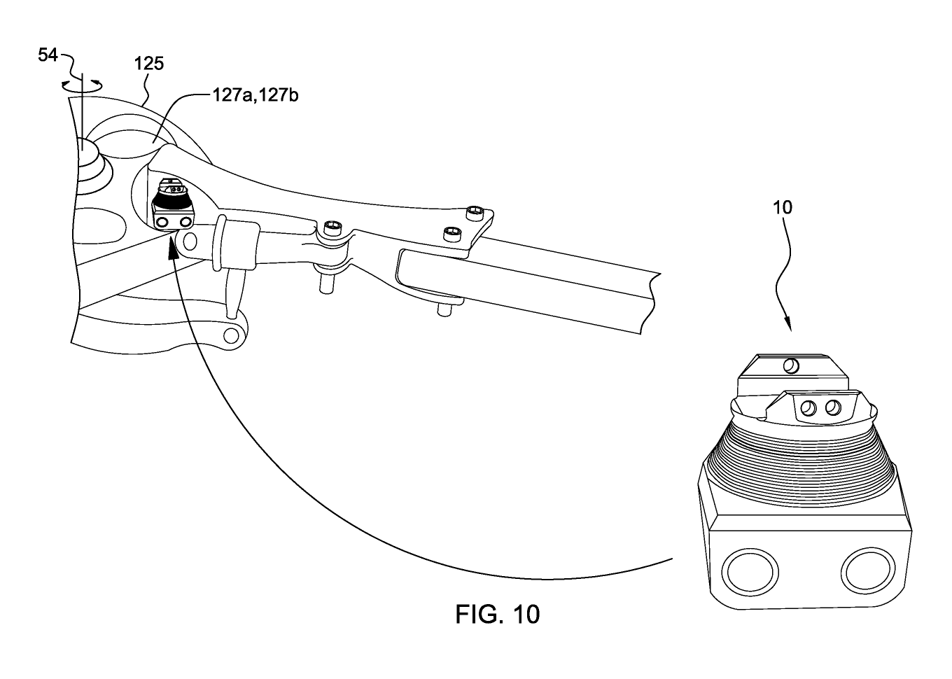

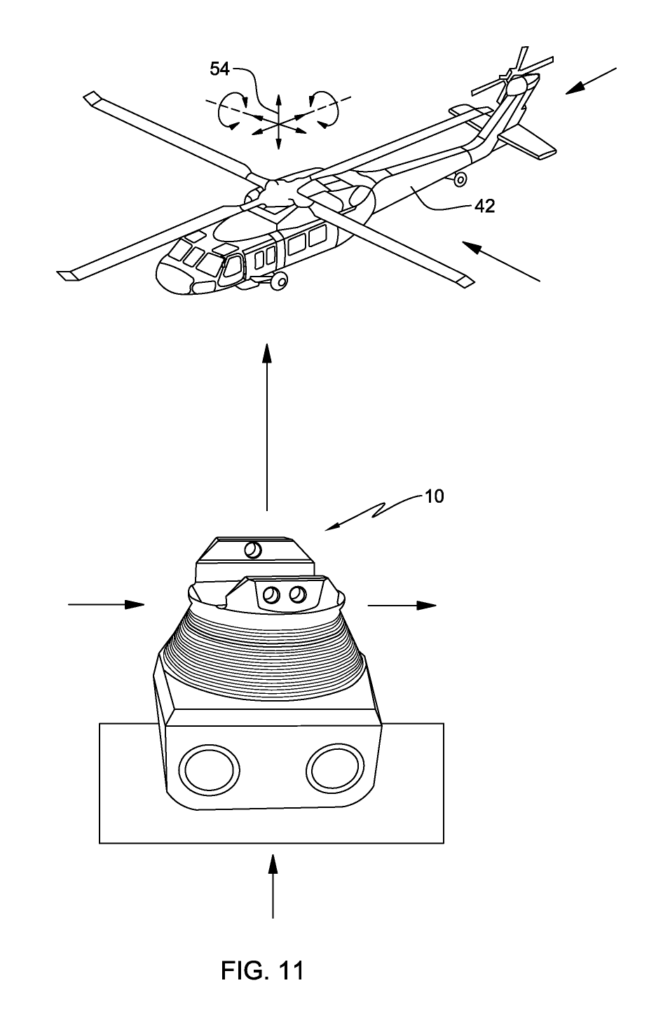

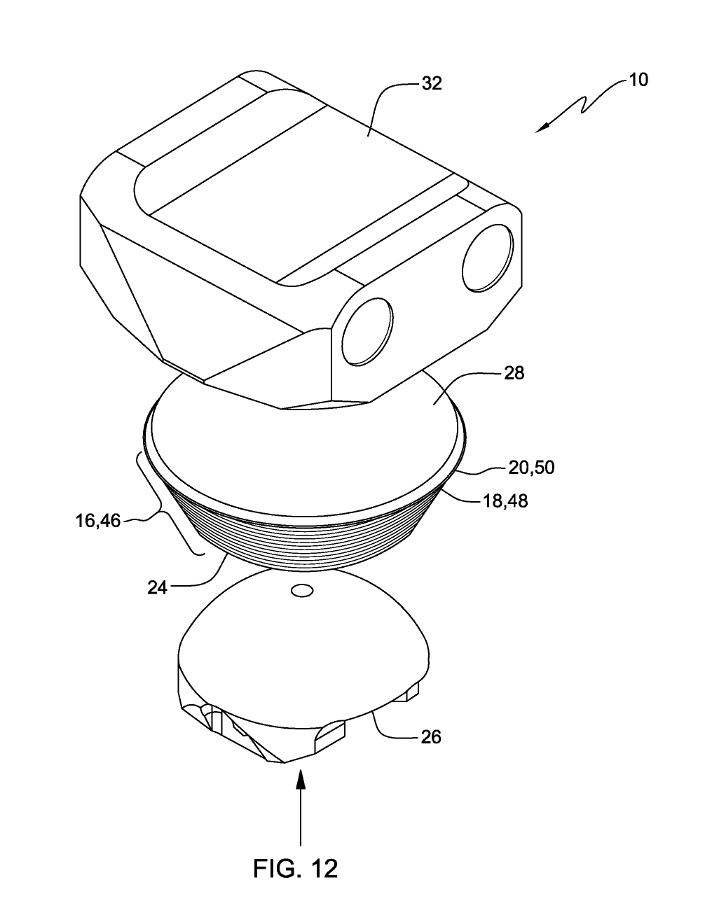

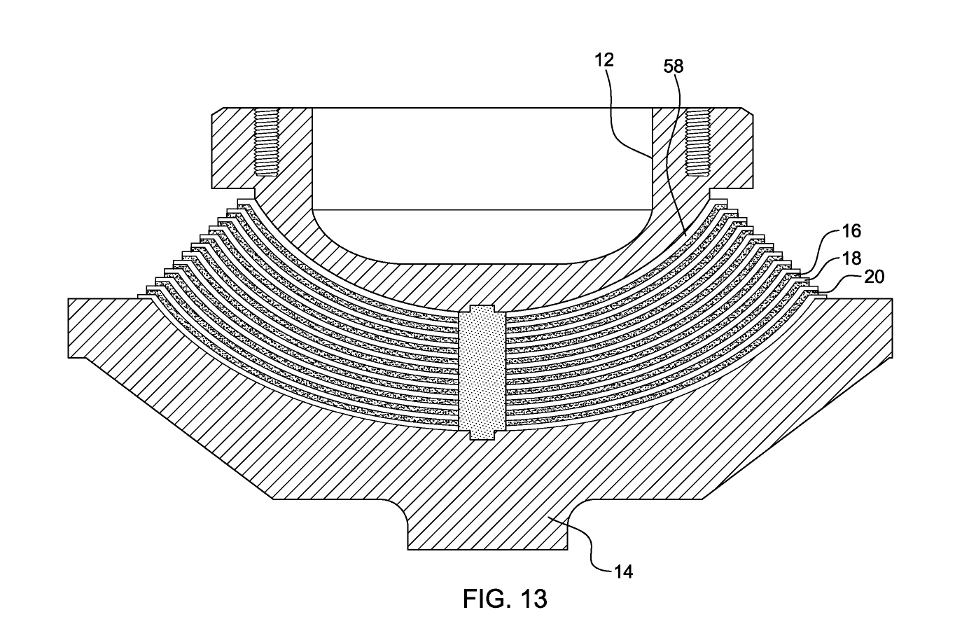

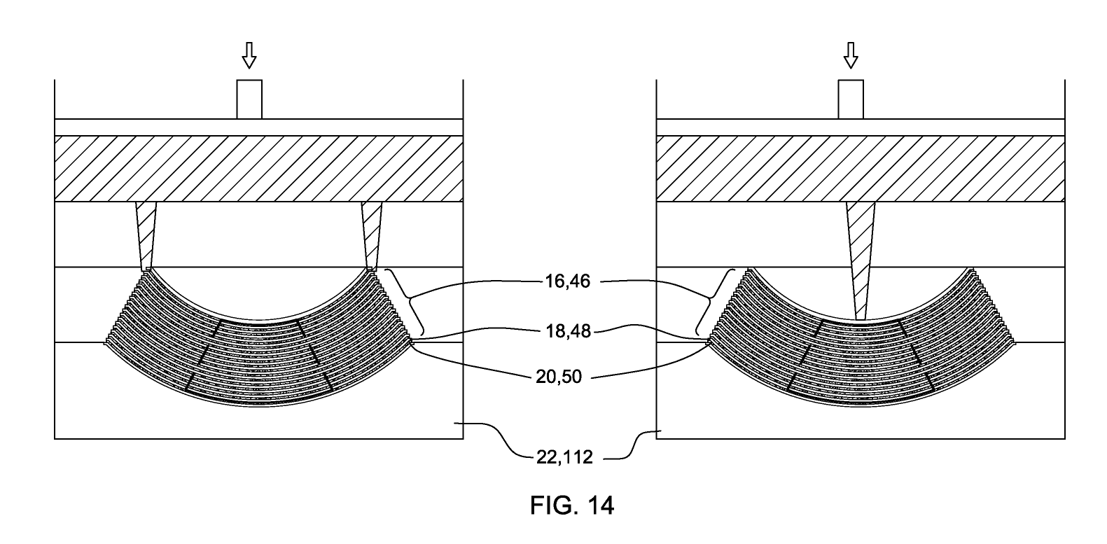

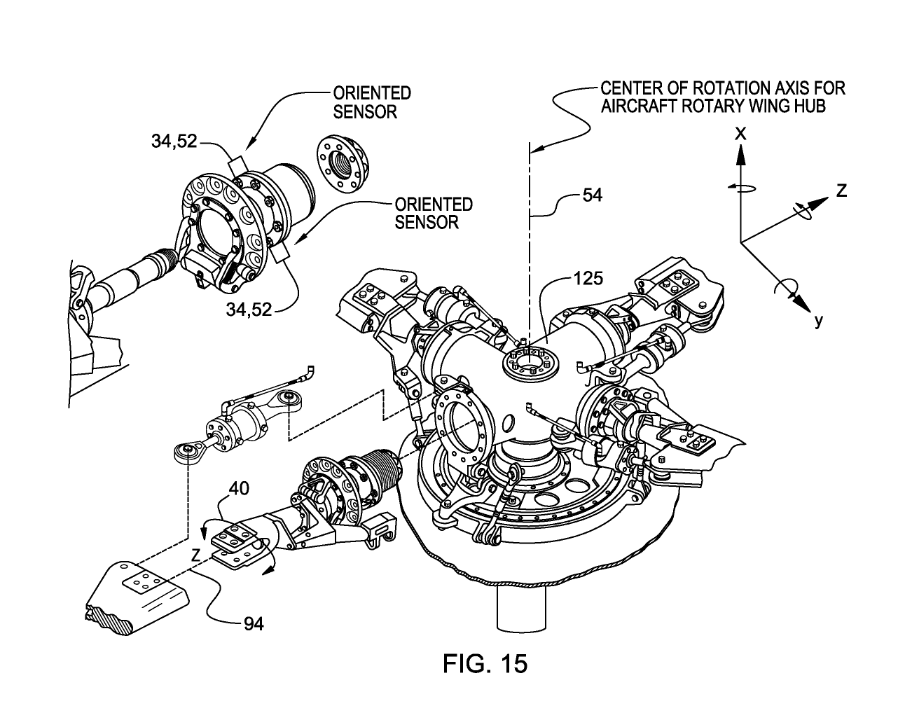

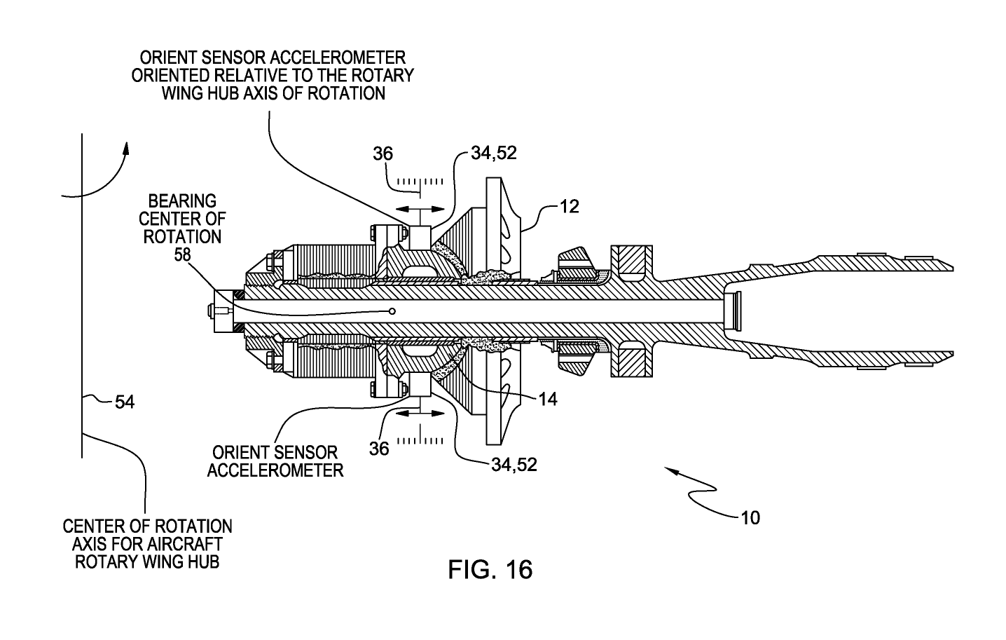

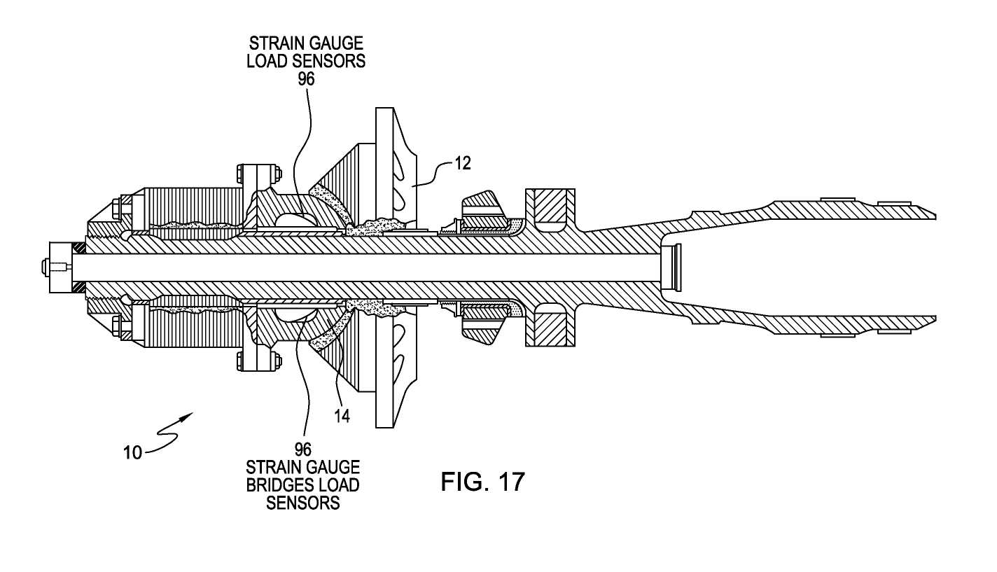

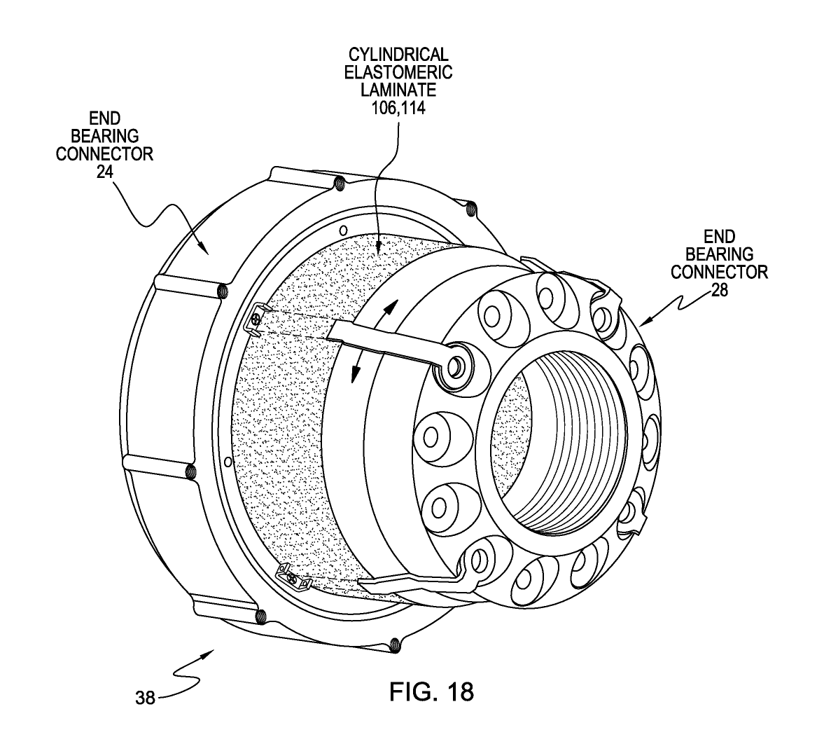

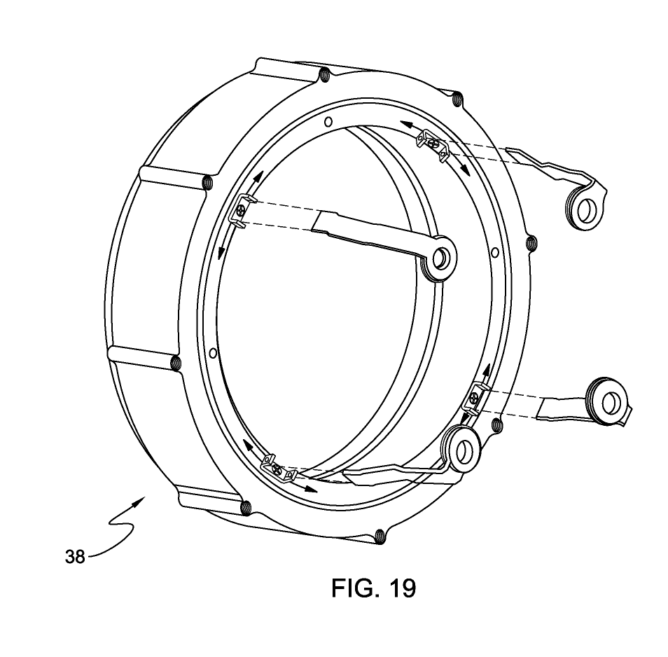

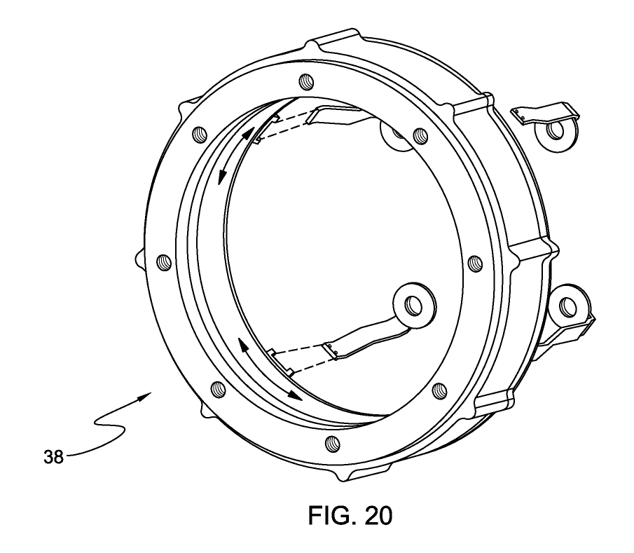

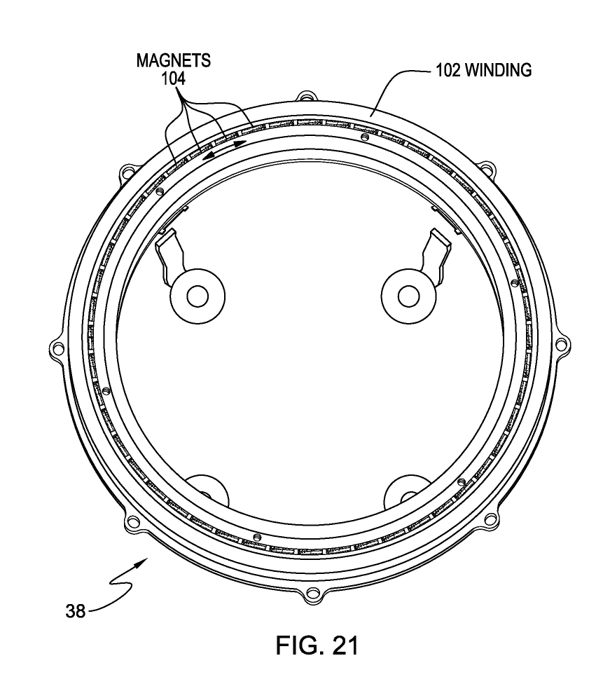

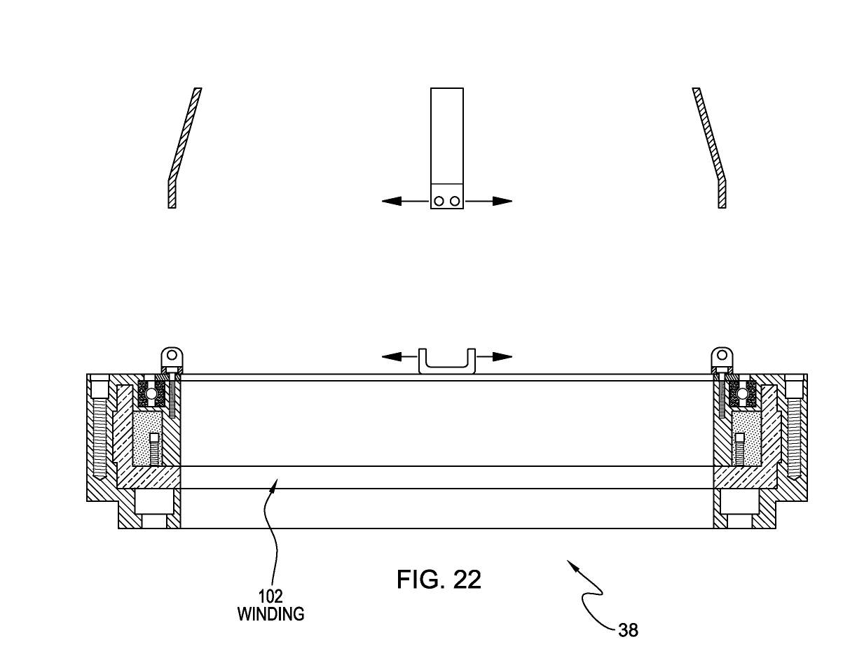

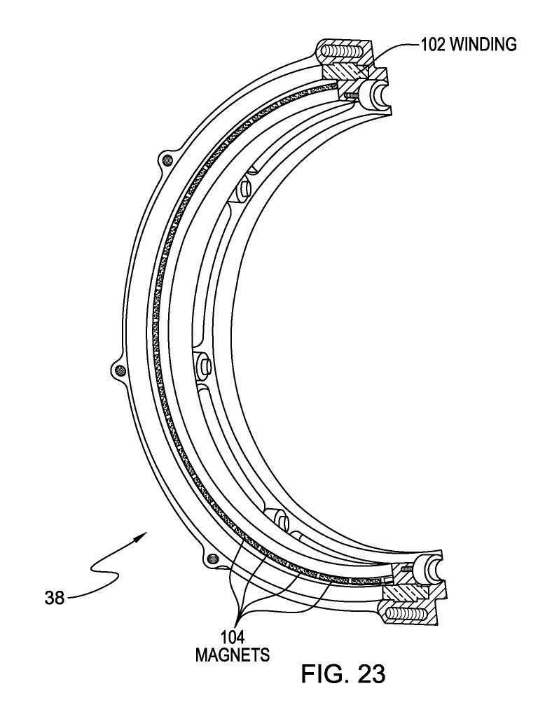

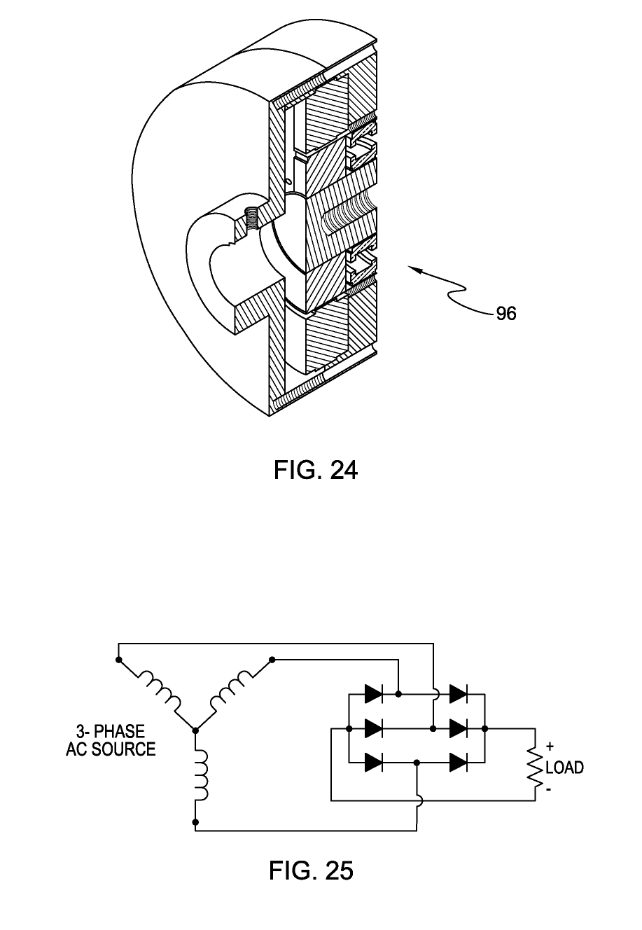

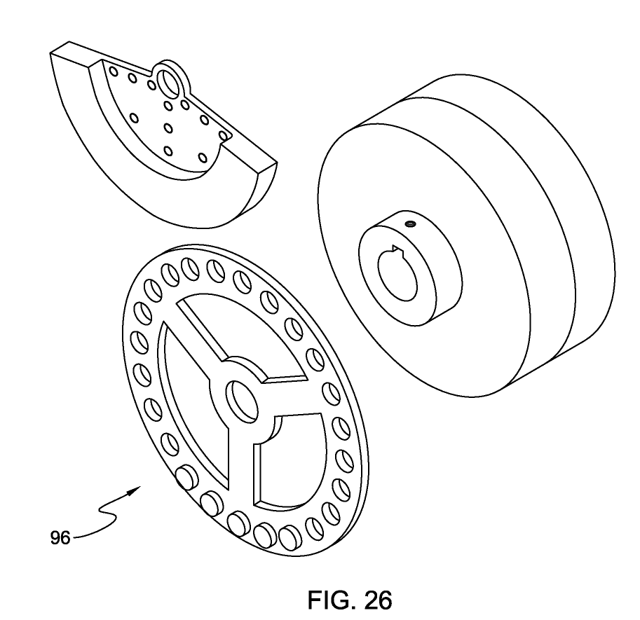

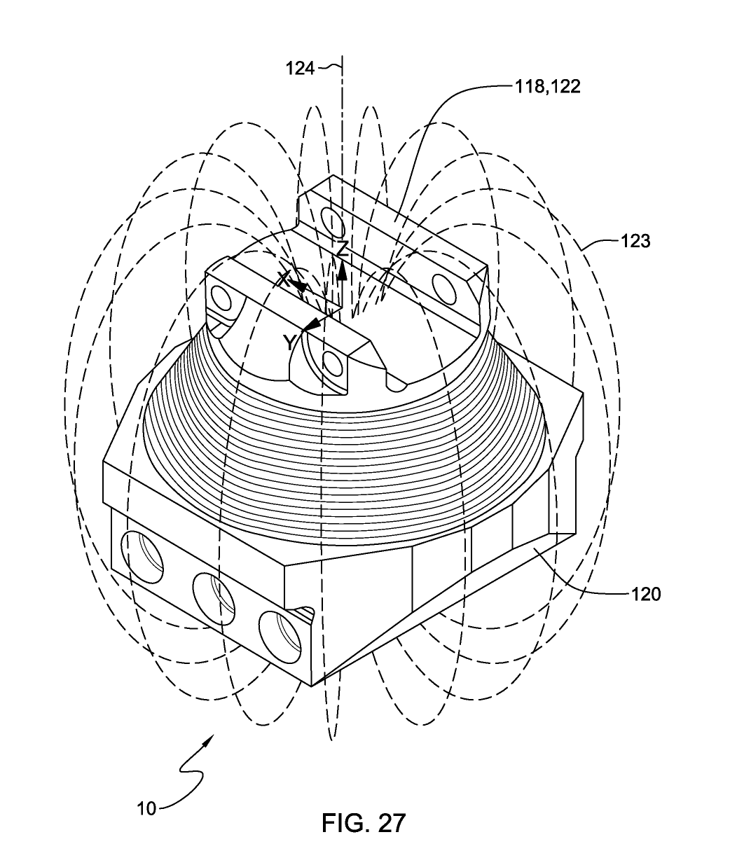

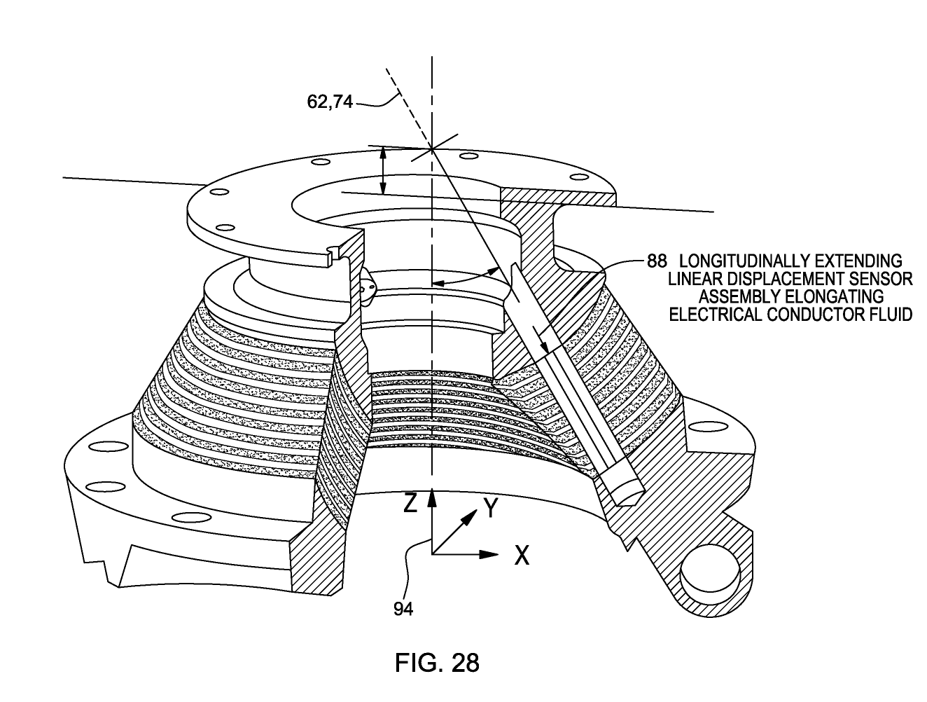

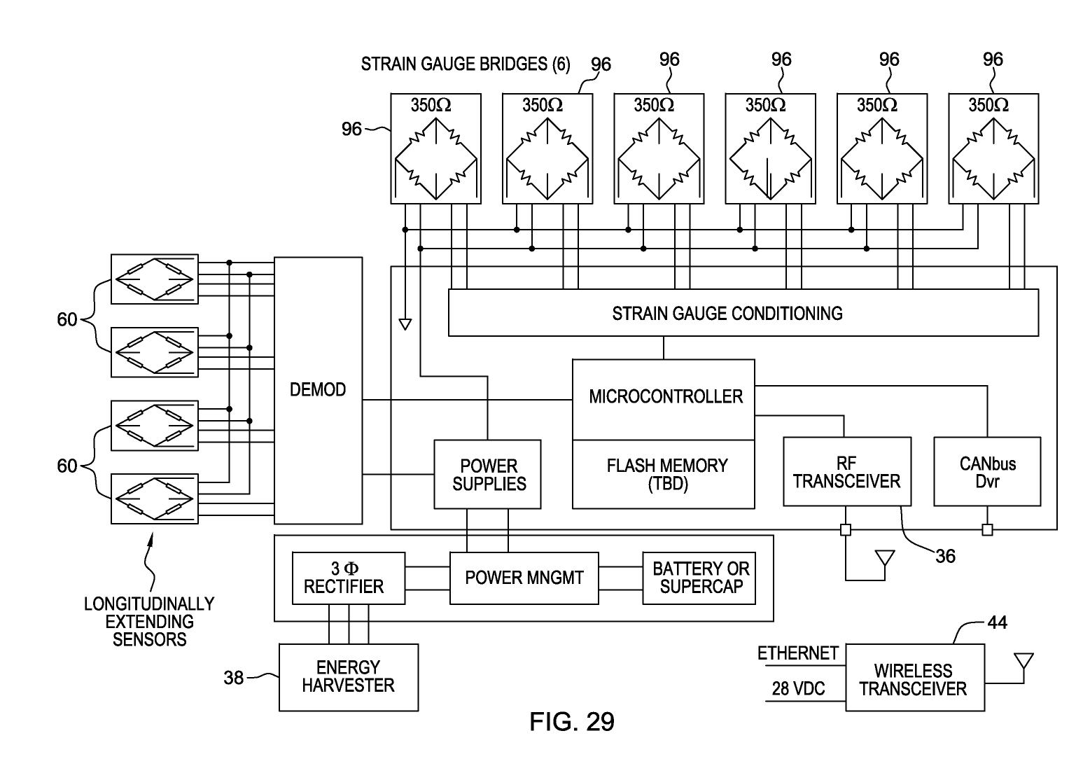

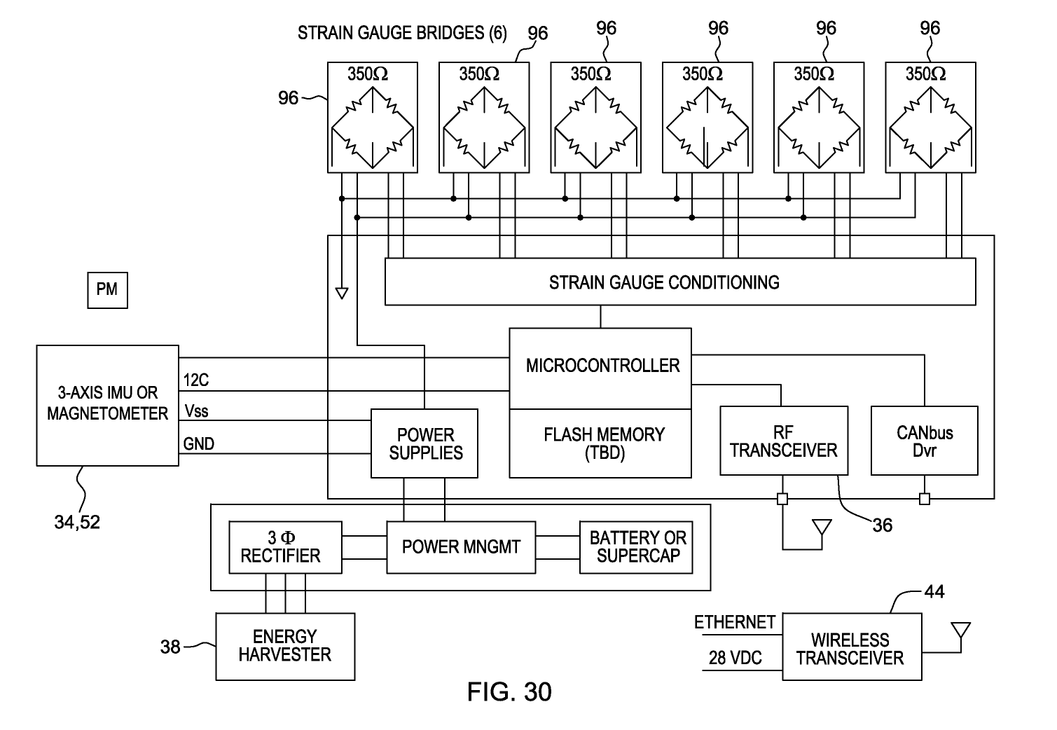

In an embodiment, the invention includes a rotary wing aircraft motion control bearing device 10, hereinafter bearing device 10. The bearing device 10 provides a constrained relative motion between a first rotary wing aircraft control member 12 and a second rotary wing aircraft control member 14, hereinafter first control member 12 and second control member 14. The bearing device 10 includes an elastomeric mold bonded laminate 16. The elastomeric mold bonded laminate 16, is hereinafter referred to as elastomeric laminate 16. Although illustrated in FIGS. 3 and 4 as a spherical elastomeric laminate 16, elastomeric laminate 16 may be also be cylindrical.

The elastomeric laminate 16, including a plurality of mold bonded alternating layers of interiorly positioned nonelastomeric shims 18 and elastomeric shims 20, preferably vulcanized bonded inside an elastomeric curing mold 22 which contains and positions the shims 18, 20 during an applied mold pressure and temperature to provide elastomeric laminate 16 of cured elastomer shims 20 and nonelastomeric shims 18. The plurality of mold bonded alternating layers make up the bonded spherical elastomeric bearing package of elastomeric laminate 16.

The bearing device 10 includes a first end bearing connector 24 bonded with a first end 26 of the elastomeric laminate 16, the first end bearing connector 24 for grounding with the first controlled member 12, the bearing device 10 including a second end bearing connector 28 nonelastomeric metal member bonded with a second distal end 32 of the elastomeric laminate 16, the bearing device 10 second end bearing connector 28 for grounding with the second control member 14.

The bearing device 10 includes at least a first sensor member 34, the first sensor member 34 coupled with the first end bearing connector 24. The bearing device 10 includes a sensor data wireless transceiver transmitter 36 and a kinetic energy ambient environmental power harvester 38, hereinafter a kinetic energy power harvester 38. The sensor data wireless transceiver transmitter 36 is hereinafter referred to as the wireless transmitter 36. Wireless transmitter 36 is any type of wireless transmitter that is adaptable to bearing device 10 and able to electronically communicate.

The kinetic energy power harvester 38 is disposed proximate the elastomeric laminate 16 wherein the kinetic energy power harvester 38 extracts an electrical energy from a energy source 40 associated with the rotary wing aircraft 42 to provide electrical energy in the form of electricity to the bearing device 10. Preferably, the relative motion between the first control member 12 and the second control member 14 drives the kinetic energy power harvester 38. The kinetic energy power harvester 38 provides electricity wherein the first sensor member 34 senses a movement between the first end bearing connector 24 and a second end bearing connector 28, and the wireless transmitter 36 transmits sensor data of the sensed movement to a data wireless transceiver receiver 44 and associated electronics 45. The data wireless transceiver receiver 44 is hereinafter referred to as the wireless receiver 44. Alternatively, first sensor member 34 is in electrical communication with the rotary wing aircraft 42 power supply (not shown) receives supplemental power therefrom on an as required basis.

Preferably, the elastomeric laminate 16 is comprised of a spherical shell segment 46 including a plurality of mold bonded alternating spherical segment shell layers of increasing/decreasing radius of nonelastomeric spherical segment shell layer shims 48 and elastomeric spherical segment shell layer shims 50, the first end bearing connector 24 having a spherical shell segment 46 bonded with the first end 26 of the elastomeric laminate 16, the bearing device 10 first end bearing connector 24 for grounding with the first control member 12, the bearing device 10 second distal end bearing connector 28 having a spherical shell segment 46 bonded with the second distal end 32 of the elastomeric laminate 16. Preferably the bearing device 10 is a replaceable limited use device in the rotary wing aircraft, preferably with the aircraft bearing device exchanged out for a replacement part that replaces the used bearing device.

Preferably, the bearing device 10 includes a second sensor member 52, the second sensor member 52 coupled with the first end bearing connector 24. In a preferred embodiment the first and second sensor members 34, 52 oriented and coupled on the bearing device 10 are oriented accelerometers, with the accelerometers oriented relative to the rotary wing hub axis of rotation 54. Preferably the accelerometers oriented relative to the rotary wing hub axis of rotation 54 and opposite to each other with the longitudinally extending blade axis 56 between and with the accelerometers oriented relative to the bearing center of rotation 58, preferably with the opposing accelerometers providing rotational accelerometer data from rotation about the rotary wing hub axis of rotation 54 to provide position measurement data from the sensed rotational acceleration.

Preferably, the bearing device 10 first sensor member 34 is comprised of a longitudinally extending sensor 60 extending along a longitudinal sensor axis 62 from a first sensor end 64 to a distal second end 66. Preferably, the longitudinally extending sensor 60 distal second end 66 is coupled with the second end bearing connector 28. In a preferred embodiment the longitudinally extending sensor 60 is a linear variable differential transformer. In an embodiment, the longitudinally extending sensor 60 detects a targeted detected section of the second end bearing connector 28, preferably with the longitudinally extending sensor 60 comprised of a non-contact variable differential transformer 70. The longitudinally extending sensor 60 distal second end 66 is coupled with the second end bearing connector 28 and is preferably a complementing sensor member pair end 72 to the first sensor member 34 first sensor end 64. The complementing sensor member pair ends 72 sensing a position characteristic between the first end bearing connector 24 and the second end bearing connector 28 along a longitudinally extending axis 74. The longitudinal sensor axis 62 is aligned with the longitudinally extending axis 74, a longitudinally extending linear displacement sensor assembly 78, a longitudinally extending variable reluctance transducer sensor assembly, and a longitudinally extending differential variable reluctance transducer sensor assembly. Preferably, the longitudinally extending sensor 60 is comprised of a longitudinally extending linear displacement sensor assembly 78. In embodiments the longitudinally extending sensor 60 is a displacement transducer, preferably with axial displacement between conductive surfaces changes the space between the conductive surfaces with a sensed electrical change providing sensor data relative to the displacement between the end bearing connector 24, 28.

In a preferred embodiment the longitudinally extending linear displacement sensor assembly 78 includes an elongating electrical conductor, preferably a longitudinally extending contained elongating electrical conductor fluid 88 with a change in electrical characteristic relative to elongation. In a preferred embodiment, resistance of the electrical conductor changes with the changing displacement. In a preferred embodiment, the electrical conductor is a liquid metal mass, preferably a liquid metal mass comprised of Gallium and Indium.

In preferred embodiments, the bearing device 10 includes a plurality of complementing pair longitudinally extending sensor member assemblies 90 sensing position characteristics between the first end bearing connector 24 and the second end bearing connector 28, preferably with their longitudinally extending sensor 60 having nonparallel axes. Preferably the longitudinally extending sensor member assemblies 90 extend through the spherical shell segments 46, preferably with nonparallel axis 92 oriented nonparallel to the bearing center z axis 94. Preferably four longitudinally extending sensor member assemblies 90 extend through the spherical shell segments 46, preferably with their longitudinally extending axis 74 nonparallel to each other and oriented relative to the rotary wing hub axis of rotation 54.

The bearing device 10 includes a load sensing assembly 96, the load sensing assembly 96 powered with the kinetic energy power harvester 38 with the load sensing assembly 96 transmitting load sensor data through the wireless transmitter 36 to the wireless receiver 44. Preferably the load sensing assembly 96 is comprised of a plurality of strain gauge bridges coupled with the first end bearing connector 24.

Preferably, the kinetic energy power harvester 38 includes a winding 102 and a plurality of magnets 104. Preferably, the kinetic energy power harvester 38 is an ambient kinetic energy power harvester 38 including a winding 102 and a plurality of magnets 104.

Preferably, the bearing device 10 includes a second elastomeric mold bonded laminate 106, hereinafter referred to as the second elastomeric laminate 106. The second elastomeric laminate 106 including a plurality of second elastomeric laminate 106 mold bonded alternating layers of interiorly positioned nonelastomeric shims 108 and elastomeric shims 110, preferably vulcanized bonded inside an elastomeric curing mold 112 which contains and positions the shims 108, 110 during an applied mold pressure and temperature to provide second elastomeric laminate 106 of cured elastomer shims 110 and nonelastomeric shims 108. Preferably the kinetic energy power harvester 38 is coupled with the second elastomeric laminate 106. The second elastomeric laminate 106 is a cylindrical elastomeric laminate with mold bonded alternating layers of flat planar nonelastomeric shims 108 and flat planar elastomeric shims 110, circular flat planar shims providing the cylindrical mold bonded laminate 114, and with the second elastomeric laminate 106 comprising a cylindrical mold bonded laminate pitch bearing. Cylindrical mold bonded laminate 114 is second elastomeric laminate 106 in cylindrical form.

Preferably, the bearing device 10 second elastomeric laminate 106 includes a plurality of second elastomeric laminate 106 mold bonded alternating layers of interiorly positioned nonelastomeric shims 108 and elastomeric shims 110, preferably vulcanized bonded inside an elastomeric curing mold 112 which contains and positions the shims 108, 110 during an applied mold pressure and temperature to provide second elastomeric laminate 106 of cured elastomer shims 110 and nonelastomeric shims 108. The bearing device 10 second cylindrical second elastomeric laminate 106 is coupled with the kinetic energy power harvester 38 which includes a winding 102 and a plurality of magnets 104. The bearing device 10 second cylindrical second elastomeric laminate 106 coupled with the kinetic energy power harvester 38 provides electrical power from the controlled cyclical pitching motion of the rotor wing. Preferably, the second elastomeric laminate 106 includes mold bonded alternating layers of flat planar nonelastomeric shims 108 and flat planar elastomeric shims 110, circular flat planar shims 108, 110 provide cylindrical mold bonded laminate pitch bearing.

Preferably, the bearing device 10 includes a second sensor member 52, the second sensor member 52 coupled with the second end bearing connector 28. In preferred embodiments the bearing device 10 includes a first magnetic field sensing first sensor member 118, preferably a magnetometer 118, and the second sensor member 52 is comprised of a second magnetic sensor target 120 coupled with the second end bearing connector 28. Preferably the magnetometer is a three axis magnetometer, oriented and centered on the first end bearing connector 24 longitudinally extending axis 74. The three axis magnetometer is comprised of three orthogonal vector magnetometers measuring magnetic field components including magnetic field strength, inclination and declination.

The second oriented magnetic sensor target 120 is coupled with the second end bearing connector 28. The permanent magnet target 122 is oriented and centered on the second end bearing connector 28 longitudinally extending axis 74, with the permanent magnet target 122 generating magnetic field lines 123. In an embodiment, the second end bearing connector 28 is comprised of a nonmagnetic metal, the first end bearing connector 24 is comprised of a nonmagnetic metal, and the interior nonelastomeric shims 18 are comprised of a nonmagnetic metal.

In an embodiment, the second end bearing connector 28 is comprised of a magnetic metal. In an embodiment, the first end bearing connector 24 is comprised of a magnetic metal. In an embodiment at least one of the nonelastomeric shims 18 are comprised of a magnetic metal. Preferably with the oriented magnetometer and the distal permanent magnet target 122, the relative location of the sensor within the magnet's magnetic field is measured. The magnetometer readings from the three axes is filtered and processed to produce signals which are proportional to the x, y, z axis displacement between the magnet and sensor. Preferably the magnetometer is oriented and centered on the central axis 124 of the spherical bearing 126, the magnetometer's three axes are oriented in relation to the magnetic field lines 123 of the permanent magnet target 122.

The bearing device 10 has an operational lifetime beginning spring rate SRB and an operational lifetime end spring rate SRE with SRE<SRB. Preferably, the SRE is no greater than 0.83SRB, preferably no greater than 0.81SRB, and preferably the operational lifetime end spring rate is less than eighty percent of operational lifetime beginning spring rate. The bearing device 10 has an operational lifetime OL measured by a plurality of operational deflection cycles between the first end bearing connector 24 and the second end bearing connector 28 until the operational lifetime end spring rate SRE is reached. Wherein, the bearing device 10 has the operational lifetime OL with the at least first magnetic field sensing first sensor member 118 monitoring an operational spring rate of the elastomeric laminate 16 between the first end bearing connector 24 and the second end bearing connector 28. The device monitors the operational spring rate of the elastomeric laminate 16 relative to the SRB and the SRE.

Preferably, the wireless transmitter 36 transmits sensor data to the wireless receiver 44 with the sensor data including operational spring rate data of the elastomeric laminate 16. The sensor data is used to determine replacement of the bearing device 10. The sensor data is used to monitor bearing device 10 usage, monitor and collect loading history statistics experienced by the bearing, catalog usage exceedance events (bearing events that relate to bearing stress and/or strain that exceeds predefined threshold indicating significant damage, compromised bearing life, need for near-term inspection or removal/replacement, estimate remaining bearing life, monitor loading history for tracking cumulative damage). Preferably, the rotary wing aircraft constrained relative motion operational deflection cycles compress the elastomers of the elastomeric laminate 16, compressing and/or shearing the intermediate elastomer.

Preferably, the sensors monitor operational lifetime OL cycles of at least about forty five million cycles to about eighty nine million cycles. Preferably, the sensors monitor operational lifetime OL cycles for at least about 2,450 hours at about 5 HZ to at least about 4,000 hours at about 6 Hz. The operational lifetime OL cycles, hours and frequency ranges are platform dependent and vary based upon the particular design requirements for the rotary wing aircraft 42. Preferably the spring rate cycle sensor data is used to initiate a replacement of the bearing device 10 in the aircraft, with the bearing device 10 comprised of a replaceable limited use device, preferably with the device exchanged out for a replacement part.

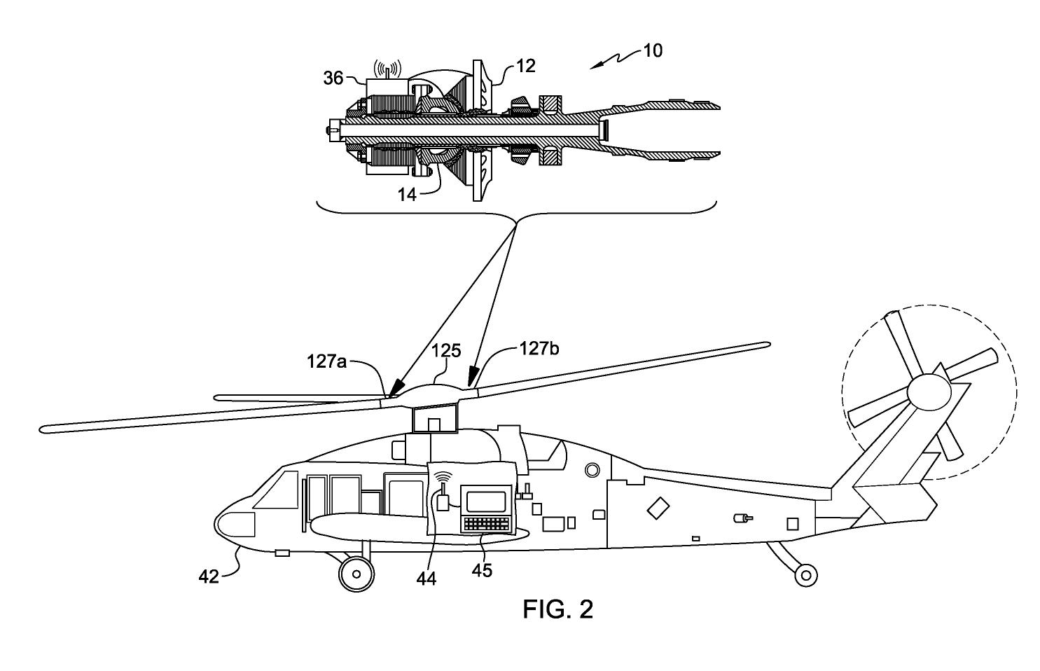

FIG. 2 illustrates the placement of bearing device 10 on rotary wing aircraft 42 near rotary wing hub 125 near blade root 127a and 127b.

In an embodiment, elastomeric laminate 16, spherical shell segment 46, and bonded spherical elastomeric package each refer to elastomer layers and shims bonded together. There are two approaches to make these parts. The first approach is by bonding nonelastomeric shims 18, 48 and elastomeric shims 20, 50 in a mold 22. The bonded shim package is then attached to first end bearing connector 24 and second end bearing connector 28. The second approach is by bonding nonelastomeric 18, 48 and elastomeric shims 20, 50 in a mold 22 together with first end bearing connector 24 and second end bearing connector 28.

In an embodiment, the invention includes a method of making a bearing device 10 for providing a constrained relative motion between a first control member 12 and a second control member 14. The method includes providing an elastomeric laminate 16, the elastomeric laminate 16 including a plurality of mold bonded alternating layers of nonelastomeric shims 18 and elastomeric shims 20. Preferably, the elastomeric laminate 16 is provided by vulcanize bonding inside an elastomeric curing mold 22 which contains and positions the shims 18, 20 during an applied mold pressure and temperature to provide the elastomeric laminate 16 of cured elastomer shims 20 and nonelastomeric shims 18. The plurality of mold bonded alternating layers make up the bonded spherical elastomeric bearing package of elastomeric laminate 16. The elastomeric laminate 16 preferably includes a first end bearing connector 24 bonded with a first end 26 of the elastomeric laminate 16. The bearing device 10 first end bearing connector 24 is for grounding with the first control member 12.

The elastomeric laminate 16 preferably includes a second end bearing connector 28 bonded with a second distal end 32 of the elastomeric laminate 16, the bearing device 10 second end bearing connector 28 for grounding with the second control member 14. The method includes providing at least a first sensor member 34, the first sensor member 34 coupled with the first end bearing connector 24, a wireless transmitter 36, and a kinetic energy power harvester 38. The kinetic energy power harvester 38 is disposed proximate the elastomeric laminate 16, wherein the kinetic energy power harvester 38 extracts an electrical energy flow from a energy source 40 to provide electricity. Preferably, energy source 40 is a kinetic energy source. Wherein the first sensor member 34 senses a movement between the first end bearing connector 24 and the second end bearing connector 28, and the wireless transmitter 36 transmits sensor data of the sensed movement to a wireless receiver 44.

Preferably, the elastomeric laminate 16 is comprised of a spherical shell segment 46 including a plurality of mold bonded alternating spherical segment shell layers of increasing/decreasing radius of nonelastomeric spherical segment shell layer shims 48 and elastomeric spherical segment shell layer shims 50. The first end bearing connector 24 has a spherical shell segment 46 bonded with the first end 26 of the elastomeric laminate 16. The bearing device 10 first end bearing connector 24 for grounding with the first control member 12, the bearing device 10 second end bearing connector 28 having a spherical shell segment 46 bonded with the second distal end 32 of the elastomeric laminate 16.

Preferably, the method includes providing a second sensor member 52, the second sensor member 52 coupled with the first end bearing connector 24. In preferred methods, the first and second sensors 34, 52 are accelerometers oriented relative to the rotary wing hub axis of rotation 54, with the coupled position of the accelerometer measured with rotational acceleration.

Preferably, the method includes the first sensor member 34 comprised of a longitudinally extending sensor 60 extending along a longitudinal sensor axis 62 from a first sensor end 64 to a distal second end 66. The longitudinally extending sensor 60 distal second end 66 is coupled with the second end bearing connector 28.

In an embodiment, the longitudinally extending sensor 60 distal second end 66 coupled with the second end bearing connector 28 is the second end bearing connector 28. In an embodiment, the longitudinally extending sensor 60 is a linear variable differential transformer. In an embodiment, the longitudinally extending sensor 60 is a non-contact variable differential transformer sensing a targeted detected section of the second end bearing connector 28.

Preferably, the longitudinally extending sensor 60 distal second end 66 coupled with the second end bearing connector 28 is preferably a complementing sensor member pair end 72 to the first sensor member 34 first sensor end 64, with the complementing sensor member pair ends 72 sensing a position characteristic between the first end bearing connector 24 and the second end bearing connector 28 preferably along a longitudinally extending axis 74 with the longitudinal sensor axis 62 aligned with the longitudinally extending axis 74. The sensor assembly comprises a longitudinally extending linear displacement sensor assembly 78, a longitudinally extending variable reluctance transducer sensor assembly, and a longitudinally extending differential variable reluctance transducer sensor assembly.

In embodiments, the sensor is a displacement transducer, preferably with axial displacement between conductive surfaces changes the space between the conductive surfaces with a sensed electrical change providing sensor data relative to the displacement between the end bearing connector 24, 28.

In embodiments, the sensor is a longitudinally extending linear displacement sensor assembly 78, preferably an elongating electrical conductor, preferably a longitudinally extending contained elongating electrical conductor fluid 88 with a change in electrical characteristic relative to elongation. Preferably, sensed change is resistance provides a sensed change in displacement. In embodiments, the longitudinally extending contained elongating electrical conductor fluid 88 is a liquid metal mass, and preferably a liquid metal mass comprised of Gallium and Indium.

Preferably, the method includes disposing a plurality of the complementing pair longitudinally extending sensor member assemblies 90 sensing position characteristics between the first end bearing connector 24 and the second end bearing connector 28, preferably with their longitudinally extending axis 74 nonparallel. The longitudinally extending sensor member assemblies 90 extend through the spherical shell segments 46. Preferably, four longitudinally extending sensor member assemblies 90 extend through the spherical shell segments 46, preferably with their longitudinally extending axis 74 nonparallel to each other and oriented relative to relative to the rotary wing hub axis of rotation 54.

Preferably, the method includes providing a load sensing assembly 96, the load sensing assembly 96 powered with the kinetic energy power harvester 38 with the load sensing assembly 96 transmitting load sensor data through the wireless transmitter 36 to the wireless receiver 44. Preferably, the load sensing assembly 96 is comprised of a plurality of strain gauge bridges coupled with the first end bearing connector 24.

Preferably, the method includes providing a kinetic energy power harvester 38 with a winding 102 and a plurality of magnets 104. Preferably the kinetic energy power harvester 38 includes a winding 102 and a plurality of magnets 104 centered and coupled about a second elastomeric laminate 106 with controlled rotary wing cyclical motions.

Preferably, the method includes providing a second elastomeric laminate 106, the second elastomeric laminate 106 including a plurality of second elastomeric mold bonded laminate mold bonded alternating layers of interiorly positioned nonelastomeric shims 108 and elastomeric shims 110. The method includes vulcanize bonding inside an elastomeric curing mold 112 which contains and positions the shims during an applied mold pressure and temperature to provide the second elastomeric laminate 106 of cured elastomer shims 110 and nonelastomeric shims 108. Preferably the kinetic energy power harvester 38 is coupled with the second elastomeric laminate 106. The second elastomeric laminate 106 is mold bonded alternating layers of flat planar nonelastomeric shims 108 and flat planar elastomeric shims 110, preferably circular flat planar shims providing a cylindrical mold bonded laminate, preferably cylindrical mold bonded laminate pitch bearing for controlling rotary wing cyclical motions.

Preferably, the method includes providing a second elastomeric laminate 106, the second elastomeric laminate 106 including a plurality of second elastomeric mold bonded laminate mold bonded alternating layers of interiorly positioned nonelastomeric shims 108 and elastomeric shims 110, preferably vulcanize bonding inside an elastomeric curing mold 112 which contains and positions the shims during an applied mold pressure and temperature to provide second elastomeric laminate 106 of cured elastomer shims 110 and nonelastomeric shims 108. Preferably, the kinetic energy power harvester 38 includes a winding 102 and a plurality of magnets 104, with the kinetic energy power harvester 38 coupled with the second elastomeric laminate 106. Preferably, the second elastomeric laminate 106 is comprised of mold bonded alternating layers of flat planar nonelastomeric shims 108 and flat planar elastomeric shims 110, preferably circular flat planar shims to provide cylindrical mold bonded laminate 114, preferably a cylindrical mold bonded laminate pitch bearing. Cylindrical mold bonded laminate 114 is second elastomeric laminate 106 in cylindrical form.

Preferably, the method includes providing a second sensor member 52, the second sensor member 52 coupled with the second end bearing connector nonelastomeric 28. Preferably, the second sensor member 52 coupled with the second end bearing connector 28 is a magnet. In preferred embodiments, the bearing device 10 is provided with a first magnetic field sensing first sensor member 34, preferably a magnetometer, and the second sensor member 52 is comprised of a second magnetic sensor target 120 coupled with the second end bearing connector 28. Preferably, the provided magnetometer is a three axis magnetometer, oriented and centered on the first end bearing connector 24 longitudinally extending center axis 74. The three axis magnetometer is comprised of three orthogonal vector magnetometers measuring magnetic field components including magnetic field strength, inclination and declination. The second magnetic sensor target 120 is coupled with the second end bearing connector 28, and the permanent magnet target 122 is oriented and centered on the second end bearing connector 28 longitudinally extending axis 74, with the permanent magnet target 122 generating magnetic field lines 123.

In an embodiment the second end bearing connector 28 is comprised of a nonmagnetic metal; the first end bearing connector 24 is comprised of a nonmagnetic metal; and the nonelastomeric shims 18 are comprised of a nonmagnetic metal. In an embodiment, the second end bearing connector 28 is comprised of a magnetic metal. In an embodiment, the first end bearing connector 24 is comprised of a magnetic metal. In an embodiment, at least one of the nonelastomeric shims 18 are comprised of a magnetic metal. Preferably, with the magnetometer sensors and the distal permanent magnet targets, the relative location of the sensor within the magnet's magnetic field is measured. Preferably the magnetometer readings from the three axes is filtered and processed to produce signals which are proportional to the x, y, z axis displacement between the magnet and sensor. Preferably the magnetometer sensor is oriented and centered on the central axis of the spherical bearing, the sensor's three axes are oriented in relation to the magnetic field lines 123 of the permanent magnet target 122.

The bearing device 10 has an operational lifetime beginning spring rate SRB and an operational lifetime end spring rate SRE with SRE<SRB. Preferably, the bearing device 10 has an operational lifetime beginning spring rate SRB and an operational lifetime end spring rate SRE with SRE<SRB. Preferably, the SRE is no greater than 0.83SRB, preferably no greater than 0.81SRB, and preferably the operational lifetime end spring rate is less than eighty percent of operational lifetime beginning spring rate. Preferably, the bearing device 10 has an operational lifetime OL measured by a plurality of operational deflection cycles between the first end bearing connector nonelastomeric metal member 24 and the second end bearing connector 28 until the operational lifetime end spring rate SRE is reached, wherein the bearing device 10 has the operational lifetime OL with the at least first sensor member 34 monitoring an operational spring rate of the elastomeric laminate 16 between the first end bearing connector nonelastomeric metal member 24 and the second end bearing connector 28.

Preferably, the bearing device 10 monitors the operational spring rate of the elastomeric laminate 16 relative to the SRB and the SRE. Preferably, the wireless transmitter 36 transmits sensor data to the wireless receiver 44 with the sensor data including operational spring rate data of the elastomeric laminate 16. Preferably, the sensor data is used to determine replacement of the bearing device 10. Preferably the sensor data is used to monitor bearing usage, preferably monitor and collect loading history statistics experienced by the bearing, catalog usage exceedance events (bearing events that relate to bearing stress and/or strain that exceeds predefined threshold indicating significant damage, compromised bearing life, need for near-term inspection or removal/replacement, estimate remaining bearing life, monitor loading history for tracking cumulative damage).

Preferably, the rotary wing aircraft constrained relative motion operational deflection cycles compress the elastomers of the elastomeric laminate 16, preferably shearing the intermediate elastomer, preferably compressing and shearing the intermediate elastomer. Preferably, the sensors monitor operational lifetime OL cycles of at least about forty five million cycles to about eighty nine million cycles. Preferably, the sensors monitor operational lifetime OL cycles for at least about 2,450 hours at about 5 HZ to at least about 4,000 hours at about 6 Hz. The operational lifetime OL cycles, hours and frequency ranges are platform dependent and vary based upon the particular design requirements for the rotary wing aircraft 42. Preferably, the spring rate cycle sensor data is used to initiate a replacement of the bearing device 10 in the aircraft, with the bearing device 10 comprised of a replaceable limited use device, preferably with the device exchanged out for a replacement part.

The bearing device 10 preferably provides load sensing, and preferably provides prognostics data for the bearing device 10 and preferably provides load information for improved regime recognition and usage information of the aircraft. Preferably, the bearing device 10 provides load and motion sensing. Preferably, the load sensing resolves moments associated with blade flapping, lead-lag, and pitch or the rotary wing aircraft. Preferably, the sensors provide for measuring in-plane and centrifugal forces with the bearing measuring loads in six degrees-of-freedom. The bearing device 10 preferably provides comprehensive loads and motions data on the rotor head, including six degrees-of-freedom blade/hub load sensing related to helicopter usage, regime recognition and fatigue cycles. The bearing device 10 preferably provides three axes of dynamic motion measurement (pitch, lead/lag, and flap) with real-time stiffness monitoring of the bearing for assessing both bearing and blade health. The bearing device 10 preferably provides static and dynamic blade orientation for the aircraft including information on flight regime, thrust vectors, and gross vehicle weight.

Preferably the bearing device's 10 power harvesting provides for powering wireless communication of data to the fixed frame of the aircraft. The bearing device 10 preferably includes Moment Sensors, preferably strain gauges coupled to the spherical bearing end bearing connector member 128 to provide measurements of pitch, lead/lag and flap moments, preferably with full bridge strain gauges. The bearing device 10 preferably includes Force Sensors, preferably sensors providing measurements of in-plane, vertical and centrifugal loads. The bearing device 10 preferably includes Inertial Sensors, preferably located proximate the bearing device electronics module 130 to provide measurement of inertial motion in the pitch, lead/lag and flap directions, preferably providing dynamic displacements in these degrees-of-freedom. Preferably, the bearing device's 10 kinetic energy power harvester 38 is coupled to the system within the hub arm and harvests kinetic energy associated with the harmonic motion of the assembly. Preferably, the bearing device's electronics module 130 includes six strain bridges and three inertial sensors feeding into a sensor conditioning circuit. Preferably, the signal inputs are buffered and transmitted wirelessly as data packets to a fixed system transceiver. Preferably the bearing device electronics module 130 includes power management for optimal usage of harvested power.

The bearing device 10 provides sensing of health through in situ dynamic stiffness measurements. The bearing device 10 provides load measurements to provide fatigue loading cycle counts and regime recognition. The bearing device 10 provides blade static position to provide regime recognition (e.g., pull-up, bank, etc) and aircraft gross weight (e.g, blade coning angle). Preferably, blade static position is provided with the inertial sensors and strain gauges to calculating bearing dynamic stiffness. Preferably, blade static position is provided with an empirical model to inferring bearing static stiffness from dynamic stiffness. Preferably, blade static position is provided with calculations from the strain gauges and static stiffness. Preferably, the bearing device 10 with longitudinally extending sensors 60 measure bearing motion, and preferably the sensor data is used in combination with load sensing data, preferably from the strain gages, to provide in situ stiffness measurements. Preferably, the bearing device 10 with longitudinally extending sensors 60 in the spherical elastomeric laminate measure bearing flap angle to provide data related to rotor coning angle relating to aircraft gross weight. Preferably, the bearing device 10, with longitudinally extending sensors 60 in the spherical elastomeric laminate, measures usage behavior and operating regime recognition pertaining to the machinery, in which they reside. Preferably, the bearing device 10 with longitudinally extending sensors 60 in the spherical elastomeric laminate measure the bearing lead-lag angle to provide data on the operating state of the helicopter. Preferably, the bearing device 10 with longitudinally extending sensors 60 in the spherical elastomeric laminate measure motions of the bearing, preferably angular-x (lead-lag), angular-y (flap), angular-z (pitch) and z-displacement (CF).

In an embodiment, the invention includes a method of making a bearing device 10. The method includes providing an elastomeric laminate 16, the elastomeric laminate 16 including a plurality of mold bonded alternating layers of nonelastomeric shims 18 and elastomeric shims 20. Preferably the elastomeric laminate 16 is provided by vulcanize bonding inside an elastomeric curing mold 22 which contains and positions the shims during an applied mold pressure and temperature to provide the elastomeric laminate 16 of cured elastomer shims 20 and bonded nonelastomeric shims 18. The plurality of mold bonded alternating layers make up the bonded spherical elastomeric bearing package of elastomeric laminate 16. The elastomeric laminate 16 includes a first end bearing connector 24 bonded with a first end 26 of the elastomeric laminate 16. The first end bearing connector 24 is preferably for grounding with a first control member 12. The elastomeric laminate 16 includes a second end bearing connector 28 bonded with a second distal end 32 of the elastomeric laminate 16. The bearing device 10 second distal end 32 second end bearing connector 28 preferably for grounding with the second control member 14. The method includes providing at least a first sensor member 34, a wireless transmitter 36, and a kinetic energy power harvester 38. The kinetic energy power harvester 38 is preferably disposed proximate the elastomeric laminate 16 wherein the kinetic energy power harvester 38 extracts an electrical energy flow to provide electricity wherein the first sensor member 34 senses a movement between the first end bearing connector 24 and the second end bearing connector 28 and the wireless transmitter 36 transmits sensor data of the sensed movement to a wireless receiver 44.

Preferably, the first sensor member 34 is coupled with the first end bearing connector 24. Preferably, the kinetic energy power harvester 38 is a kinetic energy power harvester 38. Preferably, the elastomeric laminate 16 is comprised a spherical shell segment 46 including a plurality of mold bonded alternating spherical segment shell layers of increasing/decreasing radius of nonelastomeric spherical segment shell layer shims 48 and elastomeric spherical segment shell layer shims 50, the first end bearing connector 24 having a spherical shell segment 46 bonded with the first end 26 of the elastomeric laminate 16, the bearing device 10 first end bearing connector 24 for grounding with the first control member 12, the bearing device 10 second distal end 32 second end bearing connector 28 having a spherical shell segment 46 bonded with the second distal end 32 of the elastomeric laminate 16.

Preferably, the method including providing a second sensor member 52, the second sensor member 52 coupled with the first end bearing connector 24, preferably with first and second oriented accelerometers oriented relative to an axis of rotation, preferably with positions measured with rotational acceleration.

Preferably, the first sensor member 34 is comprised of a longitudinally extending sensor 60 extending along a longitudinal sensor axis 62 from a first sensor end 64 to a distal second end 66. Preferably, the method includes the first sensor member 34 comprised of a longitudinally extending sensor 60 extending along a longitudinal sensor axis 62 from a first sensor end 64 to a distal second end 66. Preferably, the longitudinally extending sensor 60 distal second end 66 is coupled with the second end bearing connector 28. In an embodiment, the longitudinally extending sensor 60 distal second end 66 coupled with the second end bearing connector 28 is the second end bearing connector 28. In an embodiment, the longitudinally extending sensor 60 is a linear variable differential transformer. In an embodiment, the sensor is a non-contact variable differential transformer sensing a targeted detected section of the second end bearing connector 28.

Preferably, the longitudinally extending sensor 60 distal second end 66 coupled with the second end bearing connector 28 is a complementing sensor member pair end 72 to the first sensor member 34 first sensor end 64. The complementing sensor member pair ends 72 sensing a position characteristic between the first end bearing connector 24 and the second end bearing connector 28 preferably along a longitudinally extending axis 74 with the longitudinal sensor axis 62 aligned with the longitudinally extending axis 74. Preferably, the sensor assembly comprises a longitudinally extending linear displacement sensor assembly 78, preferably a longitudinally extending variable reluctance transducer sensor assembly, and preferably a longitudinally extending differential variable reluctance transducer sensor assembly. In embodiments, the longitudinally extending sensor 60 is a displacement transducer, preferably with axial displacement between conductive surfaces changes the space between the conductive surfaces with a sensed electrical change providing sensor data relative to the displacement between the end bearing connector 24, 28. In embodiments, the sensor is a longitudinally extending linear displacement sensor assembly 78, preferably an elongating electrical conductor, preferably a longitudinally extending contained elongating electrical conductor fluid 88 with a change in electrical characteristic relative to elongation. Preferably, resistance provides a sensed change in displacement. Preferably, the longitudinally extending contained elongating electrical conductor fluid 88 is a liquid metal mass, more preferably a liquid metal mass comprised of Gallium and Indium.

Preferably, the method includes disposing a plurality of the complementing pair longitudinally extending sensor member assemblies 90 sensing position characteristics between the first end bearing connector 24 and the second end bearing connector 28, with their longitudinally extending axis 74 nonparallel. Preferably, the longitudinally extending sensor member assemblies 90 extend through the spherical shell segments 46. Preferably, four longitudinally extending sensor member assemblies 90 extend through the spherical shell segments 46, with their longitudinally extending axis 74 nonparallel to each other and oriented relative to the rotary wing hub axis of rotation 54.

Preferably, the method includes providing a load sensing assembly 96, the load sensing assembly 96 powered with the kinetic energy power harvester 38 with the load sensing assembly 96 transmitting load sensor data through the wireless transmitter 36 to the wireless receiver 44. Preferably, the load sensing assembly 96 is comprised of a plurality of strain gauge bridges coupled with the first end bearing connector 24.

Preferably, providing the kinetic energy ambient harvester 38 includes providing a kinetic energy power harvester 38 with a winding 102 and a plurality of magnets 104.

Preferably, the method includes providing a second elastomeric laminate 106, the second elastomeric laminate 106 including a plurality of second elastomeric laminate 106 mold bonded alternating layers of interiorly positioned nonelastomeric shims 108 and elastomeric shims 110. Preferably, the method includes vulcanize bonding inside an elastomeric curing mold 112 which contains and positions the shims during an applied mold pressure and temperature to provide the second elastomeric laminate 106 of cured elastomer shims 110 and nonelastomeric shims 108. Preferably, the kinetic energy power harvester 38 is coupled with the second elastomeric laminate 106. Preferably, the second elastomeric laminate 106 is mold bonded alternating layers of flat planar nonelastomeric shims 108 and flat planar elastomeric shims 110, preferably circular flat planar shims providing a cylindrical mold bonded laminate 114, preferably cylindrical mold bonded laminate pitch bearing for controlling cyclical motions.

Preferably, the method includes providing a second elastomeric laminate 106, the second elastomeric laminate 106 including a plurality of second elastomeric mold bonded laminate mold 106 bonded alternating layers of interiorly positioned nonelastomeric shims 108 and elastomeric shims 110, preferably vulcanize bonding inside an elastomeric curing mold 112 which contains and positions the shims during an applied mold pressure and temperature to provide second elastomeric laminate 106 of cured elastomer shims 110 and nonelastomeric shims 108. Preferably, the kinetic energy power harvester 38 includes a winding 102 and a plurality of magnets 104, with the kinetic energy power harvester 38 coupled with the second elastomeric laminate 106. Preferably, the second elastomeric laminate 106 is comprised of mold bonded alternating layers of flat planar nonelastomeric shims 108 and flat planar elastomeric shims 110, preferably circular flat planar shims to provide cylindrical mold bonded laminate 114, preferably a cylindrical mold bonded laminate pitch bearing.

Preferably, the method includes providing a second sensor member 52, the second sensor member 52 coupled with the second end bearing connector 28. Preferably, the second sensor member 52 coupled with the second end bearing connector 28 is a magnet. In preferred embodiments, the bearing device 10 is provided with a first magnetic field sensing first sensor member 118, preferably a magnetometer, and the second sensor member 52 is comprised of a second magnetic sensor target 120 coupled with the second end bearing connector 28. Preferably, the provided magnetometer is a three axis magnetometer, preferably oriented and centered on the first end bearing connector 24 longitudinally extending axis 74. Preferably, the three axis magnetometer is comprised of three orthogonal vector magnetometers measuring magnetic field components including magnetic field strength, inclination and declination.

Preferably, the second magnetic sensor target 120 is coupled with the second end bearing connector 28, preferably the permanent magnet target 122 is oriented and centered on the second end bearing connector 28 longitudinally extending axis 74, with the permanent magnet target 122 generating magnetic field lines 123. In an embodiment, the second end bearing connector 28 is comprised of a nonmagnetic metal, the first end bearing connector 24 is comprised of a nonmagnetic metal, and the nonelastomeric shims 18 are comprised of a nonmagnetic metal. In an embodiment, the second end bearing connector 28 is comprised of a magnetic metal. In an embodiment, the first end bearing connector 24 is comprised of a magnetic metal. In an embodiment, at least one of the nonelastomeric shims 18 are comprised of a magnetic metal. Preferably, with the magnetometer sensor and the permanent magnet target 122, the relative location of the second magnetic sensor target 120 within the magnet's magnetic field is measured. Preferably, the magnetometer readings from the three axes is filtered and processed to produce signals which are proportional to the x, y, z axis displacement between the magnet and sensor. Preferably, the magnetometer sensor is oriented and centered on the central axis of the spherical bearing. The sensor's three axes are oriented in relation to the magnetic field lines 123 of the permanent magnet target 122.

The method includes providing a bearing device 10 with an operational lifetime beginning spring rate SRB and an operational lifetime end spring rate SRE with SRE<SRB. Preferably, the bearing device 10 has an operational lifetime beginning spring rate SRB and an operational lifetime end spring rate SRE with SRE<SRB. Preferably, the SRE is no greater than 0.83SRB, preferably no greater than 0.81SRB, and preferably the operational lifetime end spring rate is less than eighty percent of operational lifetime beginning spring rate. Preferably, the bearing device 10 has an operational lifetime OL measured by a plurality of operational deflection cycles between the first end bearing connector 24 and the second end bearing connector 28 until the operational lifetime end spring rate SRE is reached. Wherein the bearing device 10 has the operational lifetime OL with the at least first sensor member 34 monitoring an operational spring rate of the elastomeric laminate 16 between the first end bearing connector nonelastomeric metal member 24 and the second end bearing member 28. Preferably, the bearing device 10 monitors the operational spring rate of the elastomeric laminate 16 relative to the SRB and the SRE. Preferably, the wireless transmitter 36 transmits sensor data to the wireless receiver 44 with the sensor data including operational spring rate data of the elastomeric laminate 16. Preferably, the sensor data is used to determine replacement of the bearing device 10. Preferably, the sensor data is used to monitor bearing usage, preferably monitor and collect loading history statistics experienced by the bearing, catalog usage exceedance events (bearing events that relate to bearing stress and/or strain that exceeds predefined threshold indicating significant damage, compromised bearing life, need for near-term inspection or removal/replacement, estimate remaining bearing life, monitor loading history for tracking cumulative damage). Preferably, the constrained relative motion operational deflection cycles compress the elastomers of the elastomeric laminate 16, preferably shearing the intermediate elastomer, preferably compressing and shearing the intermediate elastomer.

Preferably, the sensors monitor operational lifetime OL cycles of at least about forty five million cycles to about eighty nine million cycles. Preferably, the sensors monitor operational lifetime OL cycles for at least about 2,450 hours at about 5 HZ to at least about 4,000 hours at about 6 Hz. The operational lifetime OL cycles, hours and frequency ranges are platform dependent and vary based upon the particular design requirements for the rotary wing aircraft 42. Preferably the spring rate cycle sensor data is used to initiate a replacement of the bearing device 10, with the bearing device 10 comprised of a replaceable limited use device, preferably with the device exchanged out for a replacement part.

In an embodiment, the invention includes a bearing device 10, the bearing device 10 providing a constrained relative motion between a first control member 12 and a second control member 14. The bearing device 10 includes an elastomeric laminate 16, the elastomeric laminate 16 including a plurality of mold bonded alternating layers of nonelastomeric shims 18 and elastomeric shims 20. The elastomeric laminate 16 is preferably vulcanized bonded inside an elastomeric curing mold 22 which contains and positions the shims during an applied mold pressure and temperature to provide an elastomeric laminate 16 of cured elastomer shims 20 and nonelastomeric shims 18. The bearing device 10 includes a first end bearing connector 24 bonded with a first end 26 of the elastomeric laminate 16, the first end bearing connector 24 for grounding with the first control member 12. The bearing device 10 including a second end bearing connector 28 bonded with a second distal end 32 of the elastomeric laminate 16, the second end bearing connector 28 for grounding with the second control member 14. The elastomeric laminate 16 can be attached to the first end bearing connector 24 and the second end bearing connector 28 after the elastomeric laminate 16 is cured in the elastomeric curing mold 22. Sensor members 34, 52 may be attached after the elastomeric laminate 16 is cured in the elastomeric curing mold 22.

The bearing device 10 includes a means for sensing and a means for powering the sensing means, wherein the sensing means senses a movement between the first end bearing connector 24 and the second end bearing connector 28, and transmits sensor data of the sensed movement to a wireless receiver 44. Preferably, the elastomeric laminate 16 is comprised of a spherical shell segment 46 including a plurality of mold bonded alternating spherical segment shell layers of increasing/decreasing radius of interiorly positioned nonelastomeric spherical segment shell layer shims 48 and elastomeric spherical segment shell layer shims 50, the first end bearing connector 24 having a spherical shell segment 46 bonded with the first end 26 of the elastomeric laminate 16, the rotary wing aircraft bearing first end bearing connector 24 for grounding with the first control member 12. The rotary wing aircraft bearing second end bearing connector 28 having a spherical shell segment 46 bonded with the second distal end 32 of the elastomeric laminate 16.

It will be apparent to those skilled in the art that various modifications and variations can be made to the invention without departing from the spirit and scope of the invention. Thus, it is intended that the invention cover the modifications and variations of this invention provided they come within the scope of the appended claims and their equivalents. It is intended that the scope of differing terms or phrases in the claims may be fulfilled by the same or different structure(s) or step(s).

We claim:

1. A bearing device 10 for a rotary wing aircraft, said bearing device 10 providing a constrained relative motion between a first control member 12 and a second control member 12, said bearing device 10 comprising:
an elastomeric laminate 16, said elastomeric laminate 16 including a plurality of mold bonded alternating layers of nonelastomeric shims 18 and elastomeric shims 20;
a first end bearing connector 24 bonded with a first end 26 of said elastomeric laminate 16, said first end bearing connector 24 for grounding with said first control member 12;
a second end bearing connector 28 bonded with a second distal end 32 of said elastomeric laminate 16, said second end bearing connector 28 for grounding with said second control member 14; and
at least a first sensor member 34, said first sensor member 34 coupled with said first end bearing connector 24, a wireless transmitter 36, and a kinetic energy power harvester 38, said kinetic energy power harvester 38 disposed proximate said elastomeric laminate 16, wherein said kinetic energy power harvester 38 extracts an electrical energy from an energy source 40 to provide electricity to said bearing device 10, wherein said first sensor member 34 senses a movement between said first end bearing connector 24 and said second end bearing connector 28, and said wireless transmitter 36 transmits sensor data of said sensed movement to a wireless receiver 44.

2. The bearing device 10 as claimed in claim 1, including a second sensor member 52, said second sensor member 52 coupled with said first end bearing connector 24.

3. The bearing device 10 as claimed in claim 1, said first sensor member 34 comprised of a longitudinally extending sensor 60 extending along a longitudinal sensor axis 62 from a first sensor end 64 to a distal second end 66.

4. The bearing device 10 as claimed in claim 1, including a load sensing assembly 96, said load sensing assembly 96 powered with said kinetic energy power harvester 38 with said load sensing assembly 96 transmitting load sensor data through said wireless transmitter 36 to said wireless receiver 44.

5. The bearing device 10 as claimed in claim 1, wherein said kinetic energy power harvester 38 includes a winding 102 and a plurality of magnets 104.

6. The bearing device 10 as claimed in claim 1, including a second elastomeric laminate 106, said second elastomeric laminate 106 including a plurality of second elastomeric mold bonded laminate mold bonded alternating layers of nonelastomeric shims 108 and elastomeric shims 110, with said kinetic energy power harvester 38 coupled with said second elastomeric laminate 106.

7. The bearing device 10 as claimed in claim 1, including a second elastomeric laminate 106, said second elastomeric laminate 106 including a plurality of second elastomeric laminate 106 mold bonded alternating layers of nonelastomeric shims 108 and elastomeric shims 110, with said kinetic energy power harvester 38 including a winding 102 and a plurality of magnets 104, said kinetic energy power harvester 38 coupled with said second elastomeric laminate 106.

8. The bearing device 10 as claimed in claim 1, including a second sensor member 52, said second sensor member 52 coupled with said second end bearing connector 28.

9. The bearing device 10 as claimed in claim 1, said bearing device 10 having an operational lifetime beginning spring rate SRB and an operational lifetime end spring rate SRE with SRE<SRB, with an operational lifetime OL measured by a plurality of operational deflection cycles between the first end bearing connector 24 and the second end bearing connector 28 until the operational lifetime end spring rate SRE is reached, wherein said bearing device 10 has an operational lifetime OL with said at least first sensor member 34 monitoring an operational spring rate of the elastomeric laminate 16 between the first end bearing connector 24 and the second end bearing connector 28.

10. A method of making a bearing device 10 for a rotary wing aircraft, said method comprising:
providing an elastomeric laminate 16, said elastomeric laminate 16 including a plurality of mold bonded alternating layers of nonelastomeric shims 18 and elastomeric shims 20, said elastomeric laminate 16 including a first end bearing connector 24 bonded with a first end 26 of said elastomeric laminate 16, said elastomeric laminate 16 including a second end bearing connector 28 bonded with a second distal end 32 of said elastomeric laminate 16; and
providing at least a first sensor member 34;
providing a wireless transmitter 36; and
providing a kinetic energy power harvester 38, said kinetic energy power harvester 38 disposed proximate said elastomeric laminate 16, wherein said kinetic energy power harvester 38 extracts an electrical energy from a energy source 40 to provide electricity to the bearing device 10, wherein said first sensor member 34 senses a movement between said first end bearing connector 24 and said second end bearing connector 28, and said wireless transmitter 36 transmits sensor data of said sensed movement to a wireless receiver 44.

11. The method as claimed in claim 10, the method further comprising providing a first control member 12 and a second control member 14 and constraining a relative motion therebetween.

12. The method as claimed in claim 10, said method including providing a second sensor member 52, said second sensor member 52 coupled with said first end bearing connector 24.

13. The method as claimed in claim 10, said first sensor member 34 is comprised of a longitudinally extending sensor 60 extending along a longitudinal sensor axis 62 from a first sensor end 64 to a distal second end 66.

14. The method as claimed in claim 10, said method including providing a load sensing assembly 96, said load sensing assembly 96 powered with said kinetic energy power harvester 38 with said load sensing assembly 96 transmitting load sensor data through said wireless transmitter 36 to said wireless receiver 44.

15. The method as claimed in claim 10, wherein said kinetic energy power harvester 38 includes a winding 102 and a plurality of magnets 104.

16. The method as claimed in claim 10, including providing a second elastomeric laminate 106, said second elastomeric laminate 106 including a plurality of second elastomeric laminate 106 mold bonded alternating layers of nonelastomeric shims 108 and elastomeric shims 110, with said kinetic energy power harvester 38 coupled with said second elastomeric laminate 106.

17. The method as claimed in claim 10, including providing a second elastomeric laminate 106, said second elastomeric laminate 106 including a plurality of second elastomeric laminate 106 mold bonded alternating layers of nonelastomeric shims 108 and elastomeric shims 110, with said kinetic energy power harvester 38 including a winding 102 and a plurality of magnets 104, said kinetic energy power harvester 38 coupled with said second elastomeric laminate 106.

18. The method as claimed in claim 10, including providing a second sensor member 52, said second sensor member 52 coupled with said second end bearing connector 28.

19. The method as claimed in claim 10, wherein said bearing device 10 has an operational lifetime beginning spring rate SRB and an operational lifetime end spring rate SRE with SRE<SRB, with an operational lifetime OL measured by a plurality of operational deflection cycles between the first end bearing connector 24 and the second end bearing connector 28 until the operational lifetime end spring rate SRE is reached, wherein said bearing device 10 has an operational lifetime OL with said first sensor member 34 monitoring an operational spring rate of the elastomeric laminate 16 between the first end bearing connector 24 and the second end bearing connector 28.

20. A bearing device 10, said bearing device 10 providing a constrained relative motion between a first control member 12 and a second control member 14, said bearing device 10 comprising:
an elastomeric laminate 16, said elastomeric laminate 16 including a plurality of mold bonded alternating layers of nonelastomeric shims 18 and elastomeric shims 20, said bearing device 10 including a first end bearing connector 24 bonded with a first end 26 of said elastomeric laminate 16, said first end bearing connector 24 for grounding with said first control member 12, said bearing device 10 including a second end bearing connector 28 bonded with a second distal end 32 of said elastomeric laminate 16, said second end bearing connector 28 for grounding with said second control member 14; and
a sensing means having a means for powering said sensing means, wherein said sensing means senses a movement between said first end bearing connector 24 and said second end bearing connector 28 and transmits sensor data of said sensed movement to a wireless receiver 44.

21. The bearing device 10 of claim 20, wherein the elastomeric laminate 16 is attached to the first end bearing connector 24 and the second end bearing connector 28 after the elastomeric laminate 16 is cured in the elastomeric curing mold 22.

22. The bearing device 10 of claim 22, wherein the sensing means is attached after the elastomeric laminate 16 is cured in the elastomeric curing mold 22.

23. The bearing device 10 of claim 22, wherein the sensing means is sensor member 34.

24. The bearing device 10 of claim 22, wherein the sensing means is sensor member 52.
